(19) United States
(12) Patent Application Publication
(10) Pub. No.: US 2022/0053808 A1
(43) Pub. Date: Feb. 24, 2022

(54) COMPOSITIONS OF AND METHODS FOR FORMING FERMENTED PRODUCTS

(71) Applicant: Spero Foods, Inc., Oakland, CA (US)

(72) Inventor: Phaedra Randolph, Oakland, CA (US)

(21) Appl. No.: 17/379,713

(22) Filed: Jul. 19, 2021

Related U.S. Application Data
(63) Continuation of application No. 17/069,742, filed on Oct. 13, 2020.
Application No. 17/069,742 is a continuation of application No. PCT/US2019/028899, filed on Apr. 24, 2019.
(60) Provisional application No. 62/815,286, filed on Mar. 7, 2019.
(60) Provisional application No. 62/687,141, filed on Jun. 19, 2018.
(60) Provisional application No. 62/662,037, filed on Apr. 24, 2018.

(51) Int. Cl. A23L 25/00

(52) U.S. Cl. CPC A23L 25/40; A23L 29/065; A23L 25/30

(57) ABSTRACT

Contained herein are compositions of plant-based fermented products. Compositions of plant-based fermentation products may comprise at least about 5% whole oilseed material by dry weight, greater than 5% protein by caloric value, and one or more microorganisms. Alternatively, or in addition to, the composition may comprise at least about 5% oilseed material by dry weight and one or more microorganisms capable of degrading pigmented molecular compounds. The composition may be of a white or off-white color. Plant-based fermented products may be used in plant-based yogurts, cheeses, fermented products, or any combination thereof.

### BACKGROUND

Plant-based substitutes of animal-based products are typically subpar in nutrition or taste, and/or are prohibitively expensive. The majority of non-dairy milk substitutes consumed in the United States are soy and almond derived. Almond milk has been postulated as driving the recent explosion of plant based milk interest in the United States. While almond milk has promoted adoption of plant based milks into the American diet, almonds remain an expensive ingredient to source. Additionally, non-dairy, oil-based cheese substitutes are fundamentally different from dairy cheese in terms of composition.

### SUMMARY

The present disclosure provides methods of manufacturing and compositions of plant-based food products, plant-based curds, and food products that may be derived from the plant-based curds, including, but not limited to, cheese, milk, yogurt, egg, and tofu-replicas. The plant-based products described herein may be efficiently produced, nutritionally dense, and have low resource intensity.

In an aspect, the present disclosure provides a method for forming a plant-based food product, comprising: (a) providing a material comprising at least about 5% squash seed material by dry weight; and (b) comminuting the material to form the plant-based food product, wherein the plant-based food product has a water content of less than or equal to 80% by weight.

In some embodiments, the plant-based food product comprises whole squash seed material. In some embodiments, the material comprises at least about 10% squash seed material by dry weight. In some embodiments, the plant-based food product is an egg substitute. In some embodiments, the egg substitute is a binding agent, leavening agent, hardening agent, gelling agent, flavoring agent, coagulating agent, or moistening agent. In some embodiments, the method further comprises adding an aqueous material to hydrate the material or the plant-based animal product to yield a solution comprising the plant-based food product. In some embodiments, the solution is a slurry. In some embodiments, the solution is a non-dairy milk. In some embodiments, the method further comprises periodically fermenting the non-dairy milk.

In some embodiments, the method further comprises thermal aggregation of the plant-based food product. In some embodiments, the method further comprises fermenting the plant-based food product to form a fermented plant-based food product. In some embodiments, the fermented plant-based food product is yogurt, kefir, sour cream, buttermilk, labneh, leben, soured milk, or lassi. In some embodiments, the material or the plant-based food product comprising one or more of flavoring agents, gelling agents, coloring agents, refined sugars, plant juices, extracts, syrups, liquid sweeteners, blended or whole fruits, fats and oils, protein isolates or protein powders, mineral supplements, preservatives, coagulating agents, flours, fungus or bacterial food products and derivatives thereof, or salts. In some embodiments, the method further comprises thermal aggregation of the plant-based food product with the use of one or more coagulating agents. In some embodiments, the material is processed by toasting, deodorizing, isolating, refining, filtering, hulling, grinding, flouring, milking, liquefying, chemical treatment active carbon exposure, steam treatment, or any combination thereof

In an aspect, the present disclosure provides a method for forming a plant-based food product, comprising: (a) providing a material comprising at least about 5% oilseed material by dry weight; and (b) comminuting the material to form the plant-based food product, wherein the plant-based food product has a water content of less than or equal to 80% by weight.

In some embodiments, the oilseed material does not include flax seed, chia seed, or hemp seed. In some embodiments, the oilseed material does not include flax seed or chia seed. In some embodiments, the plant-based food product comprises whole oilseed material. In some embodiments, the material comprises at least about 10% oilseed material by dry weight. In some embodiments, the plant-based food product is an egg substitute. In some embodiments, the egg substitute is a binding agent, leavening agent, hardening agent, gelling agent, flavoring agent, coagulating agent, or moistening agent. In some embodiments, the method further comprises adding an aqueous material to hydrate the material or the plant-based animal product to yield a solution comprising the plant-based food product. In some embodiments, the solution is a slurry. In some embodiments, the solution is a non-dairy milk. In some embodiments, the method further comprises periodically fermenting the non-dairy milk.

In some embodiments, the method further comprises thermal aggregation of the plant-based food product. In some embodiments, the method further comprises fermenting the plant-based food product to form a fermented plant-based food product. In some embodiments, the fermented plant-based food product is yogurt, kefir, sour cream, buttermilk, labneh, leben, soured milk, or lassi. In some embodiments, the material or the plant-based food product comprising one or more of flavoring agents, gelling agents, coloring agents, refined sugars, plant juices, extracts, syrups, liquid sweeteners, blended or whole fruits, fats and oils, protein isolates or protein powders, mineral supplements, preservatives, coagulating agents, flours, fungus or bacterial food products and derivatives thereof, or salts. In some embodiments, the method further comprises thermal aggregation of the plant-based food product with the use of one or more coagulating agents. In some embodiments, the material is processed by toasting, deodorizing, isolating, refining, filtering, hulling, grinding, flouring, milking, liquefying, chemical treatment active carbon exposure, steam treatment, or any combination thereof

In another aspect, the present disclosure provides a method for forming a plant-based fermentation product, comprising: (a) providing a material comprising at least about 5% oilseed material by dry weight; and (b) fermenting the material to form the fermented plant-based product, which fermenting (i) is performed using one or more microorganisms that degrade pigmented molecular compounds, and/or (ii) reduces a pigment of the plant-based fermentation product such that the plant-based fermentation product has a reduced pigment from a starting pigment or such that the pigment of the plant-based curd product is a white or off-white color.

In some embodiments, the one or more microorganisms degrade phenolic compounds. In some embodiments, the material comprises at least about 10% oilseed material by dry weight. In some embodiments, the material comprises at least about 20% oilseed material. In some embodiments, the method further comprises curdling the material using thermal aggregation, a coagulating agent, or a combination or thermal aggregation and a coagulating agent. In some embodiments, the plant-based fermentation product is yogurt, kefir, sour cream, buttermilk, labneh, leben, soured milk, or lassi.

In some embodiments, the material or the plant-based fermentation product comprising one or more of flavoring agents, gelling agents, coloring agents, refined sugars, plant juices, extracts, syrups, liquid sweeteners, blended or whole fruits, fats and oils, protein isolates or protein powders, mineral supplements, preservatives, coagulating agents, flours, fungus or bacterial food products and derivatives thereof, or salts. In some embodiments, the material is processed by toasting, deodorizing, isolating, refining, filtering, hulling, grinding, flouring, milking, liquefying, chemically processing, insoluble particle removal, active carbon exposure, steam or heat treatment, or any combination thereof.

In another aspect, the present disclosure provides a method for forming a plant-based curd product, comprising: (a) providing a material comprising at least 10% whole oilseed material by dry weight; (b) combining the material with one or more protein powders or protein isolates to form a mixture; and (c) curdling the material to form the plant-based curd product, wherein the plant-based curd product has greater than 15% protein by caloric value.

In some embodiments, the material comprises at least 20% whole oilseed material. In some embodiments, the curdling comprises using a coagulating agent. In some embodiments, the coagulating agent is selected from the group consisting of proteases from Bacillus subtilis, Aspergillus oryzae, Bacillus thermoproteolyticus, Bacillus polymyxa, Endothia parasitica, Mucor miehei, Bromelain, Endothia parasitica, Mucor miehei, Saccharomyces bayous (SCY003), and others in the same Kingdoms. In some embodiments, the coagulating agent is an enzyme, bacteria, or fungus. In some embodiments, the curdling comprises thermally induced coagulation. In some embodiments, the curdling comprises the use of one or more salt coagulating agents. In some embodiments, the coagulating agent is selected from the group consisting of magnesium chloride, calcium chloride, sodium chloride, calcium sulfate, potassium chloride, glucono delta-lactone, rock salt, and any combination thereof. In some embodiments, the curdling comprises adding an acid to the material to induce coagulation.

In some embodiments, the method further comprises processing the plant-based curd composition to yield a plant-based cheese composition. In some embodiments, the material further comprises one or more materials selected from the group consisting of nuts, soybeans, nuts, legumes, grains, flours, fats and oils, protein isolates, protein powders, spices, salts, gums, starches, amino acid isolates, flavoring, plant matter, microbial matter, and animal matter. In some embodiments, the method further comprises removing off-flavors by carbon exposure, heat treatment, or both carbon exposure and heat treatment. In some embodiments, the method further comprises subjecting the plant-base curd product to fermentation, aging, drying, or any combination thereof. In some embodiments, the method further comprises emulsifying and/or mixing the plant-based curd product with oils, flours, starches, protein isolates, protein powders, flavorings, gelling agents, or any combination thereof to generate a cheese product with a moisture content of less than or equal to about 65% by weight. In some embodiments, the method further comprises fermenting or aging the plant-based curd product using one or more microorganism to alter the flavor, texture, or macronutrient content of the cheese product. In some embodiments, the curding is completed without the aid or coagulating agents, such as salts or enzymes. In some embodiments, the method further comprises fermenting the plant-based curd product using one or more microorganisms. In some embodiments, the one or more microorganisms are selected to degrade phenolic and other pigmented molecular compounds, and wherein the fermenting reduces a pigment of the plant-based curd product such that the plant-based curd product pigment is reduced from a starting pigment or such that the plant-based curd product pigment is white or off-white.

In another aspect, the present disclosure provides a method for forming a plant-based curd product, comprising: (a) providing a first material comprising at least about 10% oilseed material by dry weight; (b) curdling the second material to form the plant-based curd product and a plant-based whey product, wherein the material does not comprise an isolated or purified protein; and (c) removing or separating at least a portion of the plant-based whey product from the plant-based curd product.

In some embodiments, the first material comprises non-soluble components and the method further comprises removing or separating at least a portion of the non-soluble components from the first material. In some embodiments, the first material comprises at least 20% oilseed material. In some embodiments, the curdling comprises using a coagulating agent. In some embodiments, the coagulating agent is selected from the group consisting of proteases from Bacillus subtilis, Aspergillus oryzae, Bacillus thermoproteolyticus, Bacillus polymyxa, Endothia parasitica, Mucor miehei, Bromelain, Endothia parasitica, Mucor miehei, Saccharomyces bayous (SCY003), and others in the same Kingdoms. In some embodiments, the coagulating agent is an enzyme, bacteria, or fungus. In some embodiments, the curdling comprises thermally induced coagulation. In some embodiments, the curdling comprises the use of one or more salt coagulating agents. In some embodiments, the coagulating agent is selected from the group consisting of magnesium chloride, calcium chloride, sodium chloride, potassium chloride, calcium sulfate, glucono delta-lactone, rock salt, and any combination thereof. In some embodiments, the curdling comprises adding an acid to the material to induce coagulation.

In some embodiments, the method further comprises processing the plant-based curd composition to yield a plant-based cheese composition. In some embodiments, the first or second material further comprises one or more materials selected from the group consisting of nuts, soybeans, nuts, legumes, grains, flours, fats and oils, spices, salts, gums, starches, amino acid isolates, flavoring agents, plant matter, microbial matter or derivatives thereof, and animal matter. In some embodiments, the method further comprises removing off-flavors by carbon exposure, steam treatment, or both carbon exposure and steam treatment. In some embodiments, the method further comprises subjecting the plant-base curd product to fermentation, aging, drying, or any combination thereof. In some embodiments, the method further comprise emulsifying and/or mixing the plant-based curd product with oils, flours, starches, flavorings, gelling agents, or any combination thereof to generate cheese products with a moisture content of less than or equal to about 65% by weight. In some embodiments, the curding is completed without the aid of coagulating agents, such as salts or enzymes. In some embodiments, the method further comprises fermenting the plant-based curd product using one or more microorganisms. In some embodiments, the one or more microorganisms are selected to degrade phenolic and other pigmented molecular compounds, and wherein the fermenting reduces a pigment of the plant-based curd product such that the plant-based curd product pigment is reduced from a starting pigment or such that the plant-based curd product pigment is white or off-white.

In another aspect, the present disclosure provides a method for forming a plant-based curd product comprising: (a) providing a first material comprising at least about 10% oilseed material by dry weight; (b) curdling the second material to form the plant-based curd product and a plant-based whey product, which curdling is performed without the uses of a cross-linking enzyme; and (c) removing or separating at least a portion of the plant-based whey product from the plant-based curd product.

In some embodiments, the first material comprises non-soluble components and the method further comprises removing or separating at least a portion of the non-soluble components from the first material. In some embodiments, the first material comprises at least 20% oilseed material. In some embodiments, the curdling comprises using a coagulating agent. In some embodiments, the coagulating agent is selected from the group consisting of proteases from Bacillus subtilis, Aspergillus oryzae, Bacillus thermoproteolyticus, Bacillus polymyxa, Endothia parasitica, Mucor miehei, Bromelain, Endothia parasitica, Mucor miehei, Saccharomyces bayous (SCY003), and others in the same Kingdoms. In some embodiments, the coagulating agent is an enzyme, bacteria, or fungus. In some embodiments, the curdling comprises thermally induced coagulation. In some embodiments, the curdling comprises the use of one or more salt coagulating agents. In some embodiments, the coagulating agent is selected from the group consisting of magnesium chloride, calcium chloride, sodium chloride, potassium chloride, calcium sulfate, glucono delta-lactone, rock salt, and any combination thereof. In some embodiments, the curdling comprises adding an acid to the material to induce coagulation.

In some embodiments, the method further comprises processing the plant-based curd composition to yield a plant-based cheese composition. In some embodiments, the material further comprises one or more materials selected from the group consisting of nuts, soybeans, nuts, legumes, grains, flours, fats and oils, protein isolates, protein powders, spices, salts, gums, starches, amino acid isolates, flavoring, plant matter, microbial matter or derivatives thereof, and animal matter. In some embodiments, the method further comprises removing off-flavors by carbon exposure, steam treatment, or both carbon exposure and steam treatment. In some embodiments, the method further comprises subjecting the plant-base curd product to fermentation, aging, drying, or any combination thereof. In some embodiments, the method further comprise emulsifying and/or mixing the plant-based curd product with oils, flours, starches, protein isolates, flavorings, gelling agents, or any combination thereof to generate cheese products with a moisture content of less than or equal to about 65% by weight. In some embodiments, the curding is completed without the aid or coagulating agents, such as salts or enzymes.

In some embodiments, the method further comprises fermenting the plant-based curd product using one or more microorganisms. In some embodiments, the one or more microorganisms are selected to degrade phenolic and other pigmented molecular compounds, and wherein the fermenting reduces a pigment of the plant-based curd product such that the plant-based curd product is white or off-white.

In another aspect, the present disclosure provides a composition comprising a plant-based curd product comprising at least 10% whole oilseed material by dry weight, one or more protein isolates or protein powders, and one or more materials selected from the group consisting of nuts, soybeans, legumes, grains, flours, fats and oils, spices, salts, gums, starches, amino acid isolates, flavoring agents, plant-based materials, microbial materials, and animal-based materials.

In some embodiments, the composition comprises at least 20% whole oilseed material. In some embodiments, the composition further comprises coagulating agents. In some embodiments, the coagulating agent is selected from the group consisting of proteases from Bacillus subtilis, Aspergillus oryzae, Bacillus thermoproteolyticus, Bacillus polymyxa, Endothia parasitica, Mucor miehei, Bromelain, Endothia parasitica, Mucor miehei, Saccharomyces bayous (SCY003), and others in the same Kingdoms. In some embodiments, the coagulating agent is an enzyme, bacteria, or fungus. In some embodiments, the coagulating agent comprises one or more salts. In some embodiments, the coagulating agent is selected from the group consisting of magnesium chloride, calcium chloride, sodium chloride, potassium chloride, calcium sulfate, glucono delta-lactone, rock salt, and any combination thereof

In some embodiments, the composition further comprises a moisture content of greater than or equal to about 60% by weight. In some embodiments, the composition further comprises a moisture content between about 50% and 60% by weight. In some embodiments, the composition further comprises comprising a moisture content between about 45% and 50% by weight. In some embodiments, the composition further comprises a moisture content between about 35% and 45% by weight.

In another aspect, the present disclosure provides a composition comprising a plant-based fermentation product comprising at least about 5% whole oilseed material by dry weight, greater than 15% protein by caloric value, and one or more microorganisms selected from the group consisting of Bifidobacterium adolescentis, Bifidobacterium animalis, Bifidobacterium bifidum, Bifidobacterium breve, Bifidobacterium infantis, Bifidobacterium lactis, Bifidobacterium longum, Bifidobacterium pseudolongum, Bifidobacterium thermophilum, Candida colliculosa, Carnobactrium maltaromaticum, Enterococcus faecalis, Issatchenkia orientalis, Kazachstania exigua, Kazachstania unispora, Kocuria varians, Lactobacillus acidipiscis, Lactobacillus acidophilus, Lactobacillus brevis, Lactobacillus bulgaricus, Lactobacillus casei, Lactobacillus delbrueckii, Lactobacillus gasseri, Lactobacillus johnsonii, Lactobacillus kefiranofaciens, Lactobacillus kefiri, Lactobacillus nodensis, Lactobacillus parabrevis, Lactobacillus paracasei, Lactobacillus parakefiri, Lactobacillus salivarius, Lactobacillus tucceti, Lactococcus lactis, Leuconostoc pseudomesenteroides, Pichia fermentans, Propionibacterium freudenreichii, Pseudomonas fluorescens, Staphylococcus succinus, Streptococcus thermophilus, Streptococcus gallolyticus, Streptococcus salivarius, Yarrowia lipolytica, and Zygotorulaspora florentina.

In some embodiments, the composition comprises at least 10% whole oilseed material. In some embodiments, the whole oilseed material is selected from the group consisting of squash seeds, sunflower seeds, safflower seeds, peanuts, soybean, cotton seed, rape seed, sesame seed, hemp seed, flax seed, chia seed, mustard seed, vegetable seeds, and poppy seeds. In some embodiments, the composition further comprises one or more materials selected from the group consisting of nuts, soybeans, nuts, legumes, grains, flours, fats and oils, protein isolates, protein powders, spices, salts, gums, starches, amino acid isolates, flavoring agents, plant matter, microbial matter or derivatives thereof, and animal matter. In some embodiments, the plant-based fermentation product is yogurt, kefir, sour cream, buttermilk, labneh, leben, soured milk, cultured cream cheese, or lassi.

In another aspect, the present disclosure provides a composition comprising a plant-based fermentation product comprising at least about 5% oilseed material by dry weight, wherein the composition (i) comprises one or more microorganisms capable of degrading pigmented molecular compounds, and/or (ii) is of a white or off-white color.

In some embodiments, the one or microorganisms are capable of degrading phenolic compounds. In some embodiments, the composition comprises at least 10% oilseed material. In some embodiments, the composition comprises at least 20% oilseed material. In some embodiments, the oilseed material is selected from the group consisting of squash seeds, sunflower seeds, safflower seeds, peanuts, soybean, cotton seed, rape seed, sesame seed, hemp seed, flax seed, chia seed, mustard seed, vegetable seeds, poppy seeds, or other oily seeds. In some embodiments, the composition further comprises one or more materials selected from the group consisting of nuts, legumes, grains, flours, fats and oils, protein isolates, protein powders, spices, salts, gums, starches, amino acid isolates, flavoring agents, preservatives, nutritional supplements, plant matter, microbial matter or derivatives thereof, and animal matter. In some embodiments, the plant-based fermentation product is yogurt, kefir, sour cream, buttermilk, labneh, leben, soured milk, cultured cream cheese, or lassi.

In some embodiments, the composition further comprises coagulating agents. In some embodiments, the coagulating agent is selected from the group consisting of proteases from Bacillus subtilis, Aspergillus oryzae, Bacillus thermoproteolyticus, Bacillus polymyxa, Endothia parasitica, Mucor miehei, Bromelain, Endothia parasitica, Mucor miehei, Saccharomyces bayous (SCY003), and others in the same Kingdoms. In some embodiments, the coagulating agent is an enzyme, bacteria, or fungus. In some embodiments, the coagulating agent comprises one or more salts. In some embodiments, the coagulating agent is selected from the group consisting of magnesium chloride, calcium chloride, sodium chloride, potassium chloride, calcium sulfate, glucono delta-lactone, rock salt, and any combination thereof. In some embodiments, the composition further comprises a moisture content of greater than or equal to about 60% by weight. In some embodiments, the composition further comprises a moisture content between about 50% and 60% by weight. In some embodiments, the composition further comprises a moisture content between about 45% and 50% by weight. In some embodiments, the composition further comprises a moisture content between about 35% and 45% by weight.

In another aspect, the present disclosure provides a composition comprising a plant-based product, wherein the plant-based product comprises (i) at least about 5% whole oilseed material by dry weight and (ii) from about 5% to 30% by dry weight starch, protein isolate, protein powder, or combination thereof, wherein the plant-based product is thermoreversible and configured to undergo a phase transition from a solid phase to a semi-solid or a liquid phase at a temperature of greater than or equal to about 30° C.

In some embodiments, the plant-based product is configured to undergo the phase transition at a temperature of greater than or equal to about 50° C. In some embodiments, the composition further comprises one of more member selected from the group consisting of a hydrocolloid, gelling agent, coagulating agent, fat, protein, and flavoring agent. In some embodiments, the composition further comprises greater than or equal to about 1.5% protein by caloric value.

In some embodiments, the composition comprises at least 10% oilseed material. In some embodiments, the composition comprises at least 20% oilseed material. In some embodiments, the oilseed material is selected from the group consisting of squash seeds, sunflower seeds, safflower seeds, peanuts, soybean, cotton seed, rape seed, sesame seed, hemp seed, flax seed, chia seed, mustard seed, vegetable seeds, poppy seeds, or other oily seeds. In some embodiments, the composition further comprises one or more materials selected from the group consisting of nuts, legumes, grains, flours, fats and oils, protein isolates, protein powders, spices, salts, gums, starches, amino acid isolates, flavoring agents, preservatives, nutritional supplements, plant matter, microbial matter or derivatives thereof, and animal matter. In some embodiments, the plant-based fermentation product is yogurt, kefir, sour cream, buttermilk, labneh, leben, soured milk, cultured cream cheese, or lassi.

In some embodiments, the composition further comprises coagulating agents. In some embodiments, the coagulating agent is selected from the group consisting of proteases from Bacillus subtilis, Aspergillus oryzae, Bacillus thermoproteolyticus, Bacillus polymyxa, Endothia parasitica, Mucor miehei, Bromelain, Endothia parasitica, Mucor miehei, Saccharomyces bayous (SCY003), and others in the same Kingdoms. In some embodiments, the coagulating agent is an enzyme, bacteria, or fungus. In some embodiments, the coagulating agent comprises one or more salts. In some embodiments, the coagulating agent is selected from the group consisting of magnesium chloride, calcium chloride, sodium chloride, potassium chloride, calcium sulfate, glucono delta-lactone, rock salt, and any combination thereof. In some embodiments, the composition further comprises a moisture content of greater than or equal to about 60% by weight. In some embodiments, the composition further comprises a moisture content between about 50% and 60% by weight. In some embodiments, the composition further comprises a moisture content between about 45% and 50% by weight. In some embodiments, the composition further comprises a moisture content between about 35% and 45% by weight.

In another aspect, the present disclosure provides a plant-based product, wherein the plant-based product comprises (i) at least about 5% oilseed material by dry weight, (ii) one or more protein isolates or protein powders, and (iii) greater than or equal to about 15% protein by caloric value.

In some embodiments, the plant-based product comprises greater than or equal to about 30% protein by caloric value. In some embodiments, the composition further comprises one of more member selected from the group consisting of a hydrocolloid, gelling agent, coagulating agent, fat, protein, and flavoring agent.

In some embodiments, the composition comprises at least 10% oilseed material. In some embodiments, the composition comprises at least 20% oilseed material. In some embodiments, the oilseed material is selected from the group consisting of squash seeds, sunflower seeds, safflower seeds, peanuts, soybean, cotton seed, rape seed, sesame seed, hemp seed, flax seed, chia seed, mustard seed, vegetable seeds, poppy seeds, or other oily seeds. In some embodiments, the composition further comprises one or more materials selected from the group consisting of nuts, legumes, grains, flours, fats and oils, protein isolates, protein powders, spices, salts, gums, starches, amino acid isolates, flavoring agents, preservatives, nutritional supplements, plant matter, microbial matter or derivatives thereof, and animal matter. In some embodiments, the plant-based fermentation product is yogurt, kefir, sour cream, buttermilk, labneh, leben, soured milk, cultured cream cheese, or lassi.

In some embodiments, the composition further comprises coagulating agents. In some embodiments, the coagulating agent is selected from the group consisting of proteases from Bacillus subtilis, Aspergillus oryzae, Bacillus thermoproteolyticus, Bacillus polymyxa, Endothia parasitica, Mucor miehei, Bromelain, Endothia parasitica, Mucor miehei, Saccharomyces bayous (SCY003), and others in the same Kingdoms. In some embodiments, the coagulating agent is an enzyme, bacteria, or fungus. In some embodiments, the coagulating agent comprises one or more salts. In some embodiments, the coagulating agent is selected from the group consisting of magnesium chloride, calcium chloride, sodium chloride, potassium chloride, calcium sulfate, glucono delta-lactone, rock salt, and any combination thereof. In some embodiments, the composition further comprises a moisture content of greater than or equal to about 60% by weight. In some embodiments, the composition further comprises a moisture content between about 50% and 60% by weight. In some embodiments, the composition further comprises a moisture content between about 45% and 50% by weight. In some embodiments, the composition further comprises a moisture content between about 35% and 45% by weight.

In another aspect, the present disclosure provides a method for forming a composition comprising a plant-based product, comprising: providing a mixture comprising oilseed material, subjecting the mixture to fermentation to yield a fermentation product, and using the fermentation product or derivative thereof to form the composition comprising the plant-based product, which plant-based product comprises (i) at least about 5% oilseed material by dry weight and (ii) from about 5% to 30% by dry weight starch, protein isolate, protein powder, or combination thereof, wherein the plant-based product is thermoreversible and configured to undergo a phase transition from a solid phase to a semi-solid or liquid phase at a temperature of greater than or equal to 30° C.

In some embodiments, the plant-based product is configured to undergo the phase transition at a temperature of greater than or equal to about 50° C. In some embodiments, the plant-based product comprises one of more members selected from the group consisting of a hydrocolloid, gelling agent, coagulating agent, fat, protein, and flavoring agent. In some embodiments, the composition further comprises greater than or equal to about 1.5% protein by caloric value. In some embodiments, the method further comprises emulsifying a protein isolate with a fat or oil to form an emulsified protein and mixing the emulsified protein with the plant-based product.

In some embodiments, the first material comprises at least 20% oilseed material. In some embodiments, the curdling comprises using a coagulating agent. In some embodiments, the coagulating agent is selected from the group consisting of proteases from Bacillus subtilis, Aspergillus oryzae, Bacillus thermoproteolyticus, Bacillus polymyxa, Endothia parasitica, Mucor miehei, Bromelain, Endothia parasitica, Mucor miehei, Saccharomyces bayous (SCY003), and others in the same Kingdoms. In some embodiments, the coagulating agent is an enzyme, bacteria, or fungus. In some embodiments, the curdling comprises thermally induced coagulation. In some embodiments, the curdling comprises the use of one or more salt coagulating agents. In some embodiments, the coagulating agent is selected from the group consisting of magnesium chloride, calcium chloride, sodium chloride, potassium chloride, calcium sulfate, glucono delta-lactone, rock salt, and any combination thereof. In some embodiments, the curdling comprises adding an acid to the material to induce coagulation.

In some embodiments, the method further comprises processing the plant-based curd composition to yield a plant-based cheese composition. In some embodiments, the material further comprises one or more materials selected from the group consisting of nuts, soybeans, nuts, legumes, grains, flours, fats and oils, protein isolates, protein powders, spices, salts, gums, starches, amino acid isolates, flavoring, plant matter, microbial matter or derivatives thereof, and animal matter. In some embodiments, the method further comprises removing off-flavors by carbon exposure, steam treatment, or both carbon exposure and steam treatment. In some embodiments, the method further comprises subjecting the plant-base curd product to fermentation, aging, drying, or any combination thereof. In some embodiments, the method further comprise emulsifying and/or mixing the plant-based curd product with oils, flours, starches, protein isolates, flavorings, gelling agents, or any combination thereof to generate cheese products with a moisture content of less than or equal to about 65% by weight. In some embodiments, the curding is completed without the aid or coagulating agents, such as salts or enzymes.

In some embodiments, the method further comprises fermenting the plant-based curd product using one or more microorganisms. In some embodiments, the one or more microorganisms are selected to degrade phenolic and other pigmented molecular compounds, and wherein the fermenting reduces a pigment of the plant-based curd product such that the plant-based curd product is white or off-white.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “figure” and “FIG.” herein), of which:

FIG. 1 shows an image of an example of a baked dish comprising an example ricotta cheese product atop vegetable layered Portobello mushrooms;

FIG. 2 shows an image of an example of a chèvre cheese product coated with dried herbs;

FIG. 3 shows an image of an example of a cream cheese product;

FIG. 4 schematically illustrates an example of a process flow for forming a plant-based food product;

FIG. 5 schematically illustrates examples of plant-based food products formed from various processes;

FIG. 6 shows an image of an example of a comminuted oilseed material derived from sunflower seeds and heated to the boiling point;

FIG. 7 shows an image of an example of a plant-based milk product derived from squash seeds;

FIG. 8 shows an image of an example of a plant-based scrambled egg product derived from squash seeds that is coagulated using heat;

FIG. 9 shows an image of an example of a comminuted oilseed material derived from sunflower seed that is coagulated using bacteria without a coagulating heating step;

FIG. 10 shows an image of an example of a comminuted oilseed material derived from sunflower seeds that is coagulated using acid without a heating step;

FIG. 11 shows an image of an example of a comminuted oilseed material derived from sunflower seeds that is coagulated using an enzyme without a heating step;

FIG. 12 shows an image an example of a comminuted oilseed material derived from sunflower seeds that is coagulated using heat and a sodium chloride coagulating agent;

FIG. 13 shows an image of example plant-based curds derived from squash seeds that are coagulated using sodium chloride and calcium sulfate coagulating agents;

FIG. 14 shows an image of an example of a comminuted oilseed material derived from sunflower seeds that is coagulated using heat and a sodium chloride coagulating agent followed by draining the curds from the whey;

FIG. 15 shows an image of an example of a comminuted oilseed material derived from peanuts that is coagulated using heat and a sodium chloride and calcium sulfate coagulating agents followed by draining the curds from the whey;

FIG. 16 shows an image of an example of a comminuted oilseed material derived from peanuts that is coagulated using heat and a sodium chloride and calcium chloride coagulating agents followed by draining the curds from the whey;

FIG. 17 shows an image of an example of a squash seed tofu-like product that is coagulated using sodium chloride and calcium sulfate coagulating agents followed by draining the curds from the whey and pressing;

FIG. 18 shows an image of an example of a comminuted oilseed material derived from sunflower seeds that is coagulated using heat and a sodium chloride coagulating agent followed by draining the curds from the whey, flavoring, and aging with a bacteria to form a ricotta cheese product;

FIG. 19 shows an image of an example of a plant-based cheese product derived from squash seeds;

FIG. 20 shows an image of an example of a comminuted oilseed material derived from peanuts that is coagulated using magnesium chloride and calcium sulfate coagulating agents followed by draining the curds from the whey and aging with a bacteria and flavorings;

FIG. 21 shows a computer control system that is programmed or otherwise configured to implement methods provided herein;

FIG. 22 shows an image of a squash seed-based liquid that has been combined with irish sea moss, curdlan, salts, and flavoring agents and cooked into an omelet;

FIG. 23 shows an image of a squash seed based liquid that has been combined with carrageenan, curdlan, salts, and flavoring agents and cooked into a folded omelet;

FIG. 24 shows an image of sunflower seed slurry, without any filtration and formed into curds using steam treatment to induce thermal aggregation;

FIG. 25 shows an image of sunflower seed curds that have been comminuted, partially filtered, and coagulated using heat and acid;

FIG. 26 shows and image of sunflower and squash seed curds that have been comminuted into an aqueous mixture, partially filtered, coagulate using heat salts, and acids, and drained of whey to form a curd;

FIG. 27 shows an image of a plant-based cheese replica comprising sunflower and squash seed material formed by comminution, partial filtration, and heat induced coagulation using salts;

FIG. 28 shows an image of a plant-based ice cream replica comprising sunflower seed slurry and fruits;

FIG. 29 shows an image of a partially melted cheddar-type plant-based cheese replica comprising sunflower seed protein flour, coconut oil, agar agar, and flavoring agents; and

FIG. 30 shows an image of a melted mozzarella-type plant-based cheese replica comprising sunflower seed protein powder, coconut oil, agar agar, flavoring agents, cultured sunflower seed curds, gums, and tapioca starch.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

The term “oilseed,” as used herein, generally refers to any of several seeds from cultivated crops yielding oil, for example, including, but not limited to, sunflower (Helianthus annuus) and safflower (Carthamus tinctorius) (Family Asteraceae), cotton seed, rape seed, peanut, sesame seed, hemp seed, linseed (flax seed), chia seed, mustard seed, squash seed (Cucurbita Family, e.g., pumpkin, watermelon, cucumber, or any other squash seed), vegetable seeds, groundnut, jatropha seed, mustard seed, camelina seed, soybean, and poppy seed.

The term “cheese,” as used herein, generally refers to a composition that is formed of curds of milk (e.g., dairy or non-dairy milk) or slurry (e.g., oilseed slurry). The cheese may be a cheese replica (or cheese substitute). The cheese may not be naturally occurring.

The term “protein isolate,” as used herein, generally refers to a composition of a purified or isolated protein, or a mixture of purified or isolated proteins. The protein isolate may have a protein concentration of greater than or equal to about 60%, 70%, 80%, 90%, 95%, or more. In some examples, the protein isolate has a protein concentration of greater than or equal to about 90%. The protein isolate may be in a liquid or powder form.

The term “protein powder,” as used herein, generally refers to a powder that is mainly or substantially comprised of a protein or mixture of proteins. The protein powder may have a protein concentration of greater than 60%, 70%, 80%, 90%, 95% or more. The protein powder may be a protein concentrate powder and may have a protein concentration of greater than or equal to 80%. The protein powder may be a protein isolate.

The term “oilseed material,” as used herein, generally refers to oilseeds and/or oilseed derivatives. Oilseed materials may be processed or unprocessed (e.g., raw). Oilseeds and/or oilseed materials may include whole oilseeds, ground oilseeds, or oilseed meals.

The term “processed” or “processing,” as used herein, generally refers to altering of the state of the oilseeds using thermal, chemical, or microbial methods such as, but not limited to, refining, toasting, grinding, flouring, buttering, pulverizing with aqueous solution and subsequent filtration, protein isolation, defatting, pulverizing alone or with aqueous solution, chemical treatments, filtering, dehulling, milking, pressing, liquefying, and/or deodorizing.

The term “raw” or “unprocessed,” as used herein, generally refers to an oilseed material that has not been altered using thermal, chemical, or microbial methods. A whole or unprocessed material may be mechanically treated such that the physical appearance of the material is changed. For example, a whole or unprocessed oilseed material may be ground, pulverized, or otherwise mechanically reduced. A whole oilseed material may comprise whole oilseeds or may comprise oilseed that have been mechanically reduced to particulates, powder, and/or granules of any reduced size.

The term “whole oilseed material,” as used herein, generally refers to an oilseed material that has not been treated to remove or separate portions of the starting material. A whole material may not be filtered, centrifuged, or separated to remove select components. For example, a hydrated whole oilseed material may not be filtered to remove insoluble components.

The term “comminute” or “comminuting,” as used herein, generally refers to powdering, pulverizing, or dividing a larger material into a smaller material. For example, comminuting a bulk seed material may comprise grinding, pulverizing, or chopping the bulk seed material into particulates, powder, and/or granules of any reduced size.

The term “curdling,” as used herein, generally refers to the process of forming curds in solution (e.g., slurry) and separating the curd from the ‘whey’. Curdling may include coagulating an oilseed solution (e.g., slurry or oilseed milk) using heat, acid, coagulating agent, enzymes, or other coagulation methods. The coagulated portion of the solution may be a curd (e.g., plant-based curd) and the liquid portion of the solution may be a whey or whey-like product (e.g., plant-based whey)

The term “whey” or “whey-like,” as used herein, generally refers to the liquid portion of the solution (e.g., slurry or oilseed milk) that is separated from the curd. The whey or whey-like product may be a plant-based whey generated by curdling a plant-based material (e.g., oilseed slurry or milk).

The term “off-flavor,” as used herein, generally refers to is an unpalatable or plant-like flavor caused by inherent plant properties or generated by the presence of contaminating compounds. Such compounds may be derived from processing the starting materials into a plant-based food product. Off-flavors may include, but are not limited to, dimethyl sulfide compounds, ester compounds, acetaldehyde compounds, alcohol compounds, acidic compounds, diacetyl compounds, phenolic compounds, lipid compounds, fatty acid compounds, aromatic compounds, or any combination thereof

Plant-based food products and substitutes of animal-based products may be subpar in nutrition or taste, and/or may be prohibitively expensive to manufacture. Examples of plant-based food products may include plant-based milks, yogurts, fermented beverages, cheeses, tofu-like products, or egg-like products. The majority of non-dairy milk substitutes consumed in the United States are soy and almond derived. While almond milk has promoted adoption of plant-based milks into consumers' diets, almonds remain an expensive ingredient to source. Plant-based milks and yogurts may be derived from other varieties of nuts, also rendering them expensive. Soy milk is a less expensive alternative to almond milk. Another soy-based product that may be used as a substitute for animal-based products is tofu. Tofu may contain ample protein and minerals for adequate nutrition. However, consumers are becoming increasingly concerned about ingesting excess soy products.

Non-dairy cheese substitutes may be deficient in protein and micronutrients and may contain off-flavors that may make the product unpalatable. For example, non-dairy, oil-based cheese substitutes may be fundamentally different from dairy cheese in terms of composition, texture, and flavor, as they are generally formed via emulsions of oil and starch and/or protein isolates. Palatable non-dairy nut-based cheese substitutes may be formed by blending nuts into a milk or paste and then fermenting and/or aging with bacteria. Such replacements may lack palatability due to nonstandard textures and may be limited to niche markets due to the high price point of nuts.

Egg substitutes are another example of plant-based food products that replicate animal-based food products. Plant-based egg substitutes primarily reproduce a single function of animal based eggs. For example, the plant-based egg substitute may perform as a firming or binding agent for baking, but not perform other culinary capabilities of avian eggs (e.g., scrambling). Consumer demand and lack of palatable, nutrient-dense plant-based food products that may be used as a substitute for animal-based products indicates a need for plant-based food products that are affordable, nutritious, and palatable.

Oilseed materials may be promising substrates for plant-based food products and protein substitutes. For example, commonly-grown oilseeds, such as the sunflower (Helianthus annuus) and safflower (Carthamus tinctorius) (Family Asteraceae) and rapeseed (Family Brassicaceae), are cultivated worldwide, stemming from their prolific growth. Accordingly, oilseeds are abundant and widely available. With a large global supply, and a price point at least half that of the cheapest nut sources (e.g. sunflower and safflower seeds versus almonds and cashews), oilseed materials are a more viable source for plant based cheese product alternatives. For example, sunflower seeds can contain approximately 25% of the recommended daily intake (RDI) of magnesium per serving, ˜50% the RDI of vitamin E, 10% the RDI of zinc, ˜6 g of protein, and 7% RDI of iron, making them a nutritionally sound alternative to animal products, specifically as dairy and protein alternatives. Additionally, dairy from animals may contain inhibitors that largely prevent iron absorption. In contrast, many oilseed materials may have less of an iron-inhibiting effect, making them a substantial plant-based iron source.

Additionally, squash seed materials, which may be classified as oilseeds, may be a promising new substrate for plant-based food products and protein substitutes. For example, commonly-grown squashes, such as the pumpkin (Cucurbita pepo), are cultivated worldwide, stemming from their ability to thrive in relatively infertile soils. Accordingly, squash seeds may be abundant and widely available. As the squashes, such as pumpkins, are processed for related products, the seeds may be harvested for food use. With a large global supply, and a price point at least half that of the cheapest nut sources (e.g., pumpkin seeds versus almonds or cashews), squash seed materials may be a much more viable source for plant based dairy and egg product alternatives. They can contain approximately 20% of the recommended daily intake (RDI) of iron per serving, 15% the RDI of zinc, ˜7 g of protein, and ˜50 mg of omega 3 fatty acids, making them a nutritionally sound alternative to animal products, specifically as dairy, egg, and protein alternatives. Additionally, dairy and eggs from animals may contain inhibitors that largely prevent iron absorption. In contrast, many squash seed materials may contain a very small amount of iron inhibitors, making them a substantial plant based iron source.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

### Plant-Based Food Products

In an aspect, the present disclosure provides compositions comprising plant-based food products, such as plant-based milks, yogurts, fermented beverages, cheeses, and egg substitutes. The plant-based food products may be animal product replicas, such as cheese replicas, yogurt replicas, milk replicas, and egg replicas. The plant-based food products may have similar flavor, mouthfeel, and palatability to the animal products they are replicating. Alternatively, or in addition to, the plant-based food product may not be an animal product replica. The plant-based food product may be for human or animal consumption. The plant-based food product may be consumed as a standalone product or may be an added ingredient in another product. For example, the plant-based product may be an egg substitute and the egg substitute may be used to make cakes, breads, pastas, or any variety of other food products.

In another aspect, the present disclosure provides a composition comprising a plant-based curd product comprising at least 10% whole oilseed material by dry weight and one or more of nuts, soybeans, legumes, grains, flours, fats and oils, protein isolates, protein powders, spices, salts, gums, starches, amino acid isolates, flavorings, plant-based materials, microorganisms and animal-based materials.

In another aspect, the present disclosure provides a composition comprising a plant-based fermentation product comprising at least 5% whole oilseed material by dry weight and one or more microorganisms. The microorganisms may be microorganisms used to make fermented dairy products, such as kefir, buttermilk, lassi, labneh, yogurt, sour cream, cultured or non-cultured cream cheese, buttermilk, or any other fermented milk product.

In another aspect, the present disclosure provides a composition comprising a plant-based fermentation product comprising at least 5% oilseed material by dry weight and one or more microorganisms selected for the capability to degrade phenolic and other pigmented molecular compounds. The plant-based fermentation product may be white or off-white. Alternatively, or in addition to, the plant-based fermentation product may be reduced in color. For example, the color hue may change from grey to a lighter grey. The plant-based food product may be a cheese, tofu-like product, yogurt, milk, or fermented non-dairy beverage (e.g., kefir).

In another aspect, the present disclosure provides a plant-based product comprising (i) at least about 5% oilseed material by dry weight and (ii) from about 5% to 30% starch by dry weight. The plant-based product may be thermoreversible (e.g., melts when heated and hardens when cooled) such that it undergoes a phase transition from a solid phase to a semi-solid or liquid phase at a temperature of greater than or equal to about 30° C. The plant-based product may be a fermentation product. Alternatively, or in addition to, the plant-based product may not be a fermented product. In an example, the plant-based product is a thermoreversible (e.g., meltable) cheese replica that is not a fermentation product. The thermoreversible (e.g., meltable) cheese replica may include oilseed protein flours, flavoring agents, oils, one or more gelling agents (e.g. agar agar or carrageenan), a gum, and/or a starch. The plant-based food product may be a cheese replica. The thermoreversible cheese replica may be useful for cooking applications that use meltable cheeses (e.g., pizzas, pasta dished, omelets, etc.).

In another aspect, the present disclosure provides a plant-based product comprising (i) at least about 5% oilseed material by dry weight and (ii) greater than or equal to about 15% protein by caloric value. The plant-based product may be a non-fermented product (e.g., eggs, ice cream, etc.) or may be a fermented product (e.g., cheese, yogurt, etc.). The protein may be provided to the composition by the oilseed material or may be supplemented by another material (e.g., protein isolate or concentrate, nuts, seeds, or protein plant flour).

The plant-based product may comprise one or more oilseed materials. An oilseed material may comprise whole seeds or may comprise seeds that have been comminuted (e.g., ground or pulverized). The oilseed material may be a combination of whole seeds, comminuted seeds, processed seeds, or any combination thereof. The plant-based product may comprise greater than or equal to about 1, 2, 3, 4, 5, 6, 8, 10, or more different types of oilseed materials. The oilseeds may be one or more of soybean, peanut, rape seed (generally, those used for producing canola oil), mustard seed, camelina seed, safflower seed, sunflower seed, jatropha seed, squash seed (Cucurbita Family), sesame seed, groundnut, cotton seed, flax seed, hemp seed, poppy seed, chia seed, hemp seed, other types of oilseeds, or any combination thereof. The oilseed material may be provided to the composition as a whole or unprocessed material. Compositions formed from raw or unprocessed oilseed materials may be smooth and have a pleasant mouthfeel in the absence of removal (e.g., filtering) of insoluble materials from the oilseed material. Alternatively, or in addition to, the oilseed material may be provided to the oilseed material as a processed material for an improved texture or to provide more versatile applications. The oilseed material may include whole oilseeds, ground oilseeds, or oilseed meals. The oilseed material may not include oilseed oil separated from the oilseed meal.

The food product may be an egg-like product or egg substitute. The egg-like product or egg substitute may not be from an animal, but may have one or more properties (e.g., protein content, taste, cooking behavior) that are similar, identical or substantially identical to egg from an animal. For example, the egg-like product or egg substitute has the consistency (e.g., texture, mouthfeel, and/or taste of an egg). The egg-like product or egg substitute may have a protein content that is within 50%, 40%, 30%, 20%, 10%, or 5% of a protein content of egg (or egg yolk) from an animal (e.g., chicken).

The egg-like product or egg substitute may comprise one or more oilseeds. The oilseeds may be one or more of soybean, peanut, rape seed (generally, those used for producing canola oil), mustard seed, camelina seed, safflower seed, sunflower seed, jatropha seed, squash seed (Cucurbita Family), sesame seed, groundnut, cotton seed, flax seed, hemp seed, poppy seed, chia seed, hemp seed, or any combination thereof. In an example, the oilseed is squash seed. In another example, the oilseed is flax seed. In another example, the oilseed is hemp seed. In another example, the oilseed is chia seed. In an example, the oilseed material used for an egg-like product or egg substitute does not include flax seed or chia seed. In another example, the oilseed material used for an egg-like product or egg substitute does not include flax seed, chia seed, or hemp seed. The egg substitute may comprise greater than or equal to about 10%, 15%, 20%, 25%, 30%, 40%, 50%, 60%, 70%, 80%, 90%, 95%, or more oilseed material. The egg substitute may comprise between about 10% and 15%, 10% and 20%, 10% and 25%, 10% and 30%, 10% and 40%, 10% and 50%, 10% and 60%, 10% and 70%, 10% and 80%, 10% and 90%, or 10% and 95% oilseed material. The egg substitute may be a dry composition or may be a hydrated composition. The dry composition may have a moisture content that is less than or equal to about 50%, 40%, 30%, 25%, 20%, 15%, 10%, 5%, or less by weight. The hydrated composition may have a moisture content that is greater than or equal to about 30%, 40%, 50%, 60%, 70%, 80%, 90%, or more by weight. The hydrated composition may comprise between about 30% and 40%, 30% and 50%, 30% and 60%, 30% and 70%, 30% and 80%, or 30% and 90%. The hydrated composition may have a moisture content that is less than or equal to about 80%, 75%, 70%, 60%, 50%, or less. In an example, the egg-like product or egg substitute has a moisture content of less than or equal to 75%. In another example, the egg-like product or egg substitute has a moisture content of less than or equal to 60%. In another example, the egg-like product or egg substitute has a moisture content of less than or equal to 50%. The egg-like product may further include one or more of spices, flavoring agents, gelling agents (e.g., gellan, inulin, seaweed in whole or derivatives thereof, or bacterially produced gelling agents), sweeteners, hydrocolloids, coagulating agents, starches, flours, salts, protein isolates, protein powders, microorganisms (e.g., fungi, bacteria, or derivatives thereof), fats and oils, or animal-based products.

The egg-like product or egg substitute may comprise one or more gelling agents. Gelling agents may include gellan, inulin, seaweed in whole or derivatives thereof, agar-agar, or bacterially produced gelling agents. The egg-like product or egg substitute may comprise greater than or equal to about 0.0001%, 0.001%, 0.01%, 0.1%, 1%, 2%, 3%, 5%, 10%, or more gelling agent by weight. The egg-like product or egg substitute may comprise from about 0.0001% to 0.001%, 0.0001% to 0.01%, 0.0001% to 0.01%, 0.0001% to 0.1%, 0.0001% to 1%, 0.0001% to 1%, 0.0001% to 2%, 0.0001% to 3%, 0.0001% to 5%, 0.0001% to 10%, 0.001% to 0.01%, 0.001% to 0.1%, 0.001% to 1%, 0.001% to 2%, 0.001% to 3%, 0.001% to 5%, 0.001% to 10%, 0.01% to 0.1%, 0.01% to 1%, 0.01% to 2%, 0.01% to 3%, 0.01% to 5%, 0.01% to 10%, 0.1% to 1%, 0.1% to 2%, 0.1% to 3%, 0.1% to 5%, 0.1% to 10%, 1% to 2%, 1% to 3%, 1% to 5%, 1% to 10%, 2% to 3%, 2% to 5%, 2% to 10%, 3% to 5%, 3% to 10%, or 5% to 10% gelling agent. In an example, the egg-like product or egg substitute has from about 0.001% to 3% gelling agent.

The egg-like product may further comprise protein. The protein may be provided from the oilseed material. Alternatively, or in addition to, the protein may be an additional ingredient such as a protein isolate or protein powder. The protein isolate may be a grain protein isolate, seed protein isolate, legume protein isolate, vegetable protein isolate, fungal protein isolate, or any combination thereof. In an example, the protein isolate is a legume protein isolate. In another example, the protein isolate is a seed protein isolate. Alternatively, or in addition to, the protein isolate may be a lab grown protein source (e.g., from synthetically grown muscle tissue, egg protein, or other animal based cell). The added protein may also be a protein concentrate, a crude protein, or a protein flour. The protein isolate, protein concentrate, or crude protein may be derived from a seed, grain, or fungal source. In an example, the protein may comprise greater than or equal to about 1%, 2%, 5%, 8%, 10%, 15%, 20%, 30%, 40%, 50% or more seed material by mass. In another example, the protein may comprise greater than or equal to about 1%, 2%, 5%, 8%, 10%, 15%, 20%, 30%, 40%, 50% or more legumes, nuts, grains, or fatty fruit by mass. The added protein may be provides to the food product as a powder, flour, or moist composition. In an example, the added protein is derived from a lab grown source such as a fungal culture, bacterial culture, or synthetically produced animal cell (e.g., lab grown muscle tissue, egg protein, or other animal-type cell). The added protein may be emulsified with an oil and/or a gelling agent.

The egg-like product may have greater than or equal to about 1%, 2%, 3%, 4%, 5%, 6%, 8%, 10%, 12%, 15%, 20%, 25%, 30%, 40%, 50%, 60%, 70%, 80%, 90%, or more protein by caloric value. The egg-like product may have from about 1% to 2%, 1% to 2%, 1% to 3%, 1% to 4%, 1% to 5%, 1% to 6%, 1% to 8%, 1% to 10%, 1% to 15%, 1% to 20%, 1% to 25%, 1% to 30%, 1% to 40%, 1% to 50%, 1% to 60%, 1% to 70%, 1% to 80%, 1% to 90%, 2% to 3%, 2% to 4%, 2% to 5%, 2% to 6%, 2% to 8%, 2% to 10%, 2% to 15%, 2% to 20%, 2% to 25%, 2% to 30%, 2% to 40%, 2% to 50%, 2% to 60%, 2% to 70%, 2% to 80%, 2% to 80%, 3% to 4%, 3% to 5%, 3% to 6%, 3% to 8%, 3% to 10%, 3% to 15%, 3% to 20%, 3% to 25%, 3% to 30%, 3% to 40%, 3% to 50%, 3% to 60%, 3% to 70%, 3% to 80%, 3% to 90%, 4% to 5%, 4% to 6%, 4% to 8%, 4% to 10%, 4% to 15%, 4% to 20%, 4% to 25%, 4% to 30%, 4% to 40%, 4% to 50%, 4% to 60%, 4% to 70%, 4% to 80%, 4% to 90%, 5% to 6%, 5% to 8%, 5% to 10%, 5% to 15%, 5% to 20%, 5% to 25%, 5% to 30%, 5% to 40%, 5% to 50%, 5% to 60%, 5% to 70%, 5% to 80%, 5% to 90%, 6% to 8%, 6% to 10%, 6% to 15%, 6% to 20%, 6% to 25%, 6% to 30%, 6% to 40%, 6% to 50%, 6% to 60%, 6% to 70%, 6% to 80%, 6% to 90%, 8% to 10%, 8% to 15%, 8% to 20%, 8% to 25%, 8% to 30%, 8% to 40%, 8% to 50%, 8% to 60%, 8% to 70%, 8% to 80%, 8% to 90%, 10% to 15%, 10% to 20%, 10% to 25%, 10% to 30%, 10% to 40%, 10% to 50%, 10% to 60%, 10% to 70%, 10% to 80%, 10% to 90%, 15% to 20%, 15% to 25%, 15% to 30%, 15% to 40%, 15% to 50%, 15% to 60%, 15% to 70%, 15% to 80%, 15% to 90%, 20% to 25%, 20% to 30%, 20% to 40%, 20% to 50%, 20% to 60%, 20% to 70%, 20% to 80%, 20% to 90%, 25% to 30%, 25% to 40%, 25% to 50%, 25% to 60%, 25% to 70%, 25% to 80%, 25% to 90%, 30% to 40%, 30% to 50%, 30% to 60%, 30% to 70%, 30% to 80%, 30% to 90%, 40% to 50%, 40% to 60%, 40% to 70%, 40% to 80%, 40% to 90%, 50% to 60%, 50% to 70%, 50% to 80%, 50% to 90%, 60% to 70%, 60% to 80%, 60% to 90%, 70% to 80%, 70% to 90%, or 80% to 90% protein by caloric value. In an example, the egg-like product comprises greater than 10% protein by caloric value. In another example, the egg-like product comprises from about 10% to 70% protein by caloric value.

The egg-like product or egg substitute may coagulate or gel below a given pH. The pH may be maintained above the given pH to prevent coagulation and/or gelling. The pH of the egg-like product or egg substitute may be greater than or equal to 5.5, 6, 6.5, 7, 7.5, 8, 8.5, 9 or greater. In an example, the pH of the egg-like product or egg substitute may be greater than or equal to 6. The pH of the egg-like product or egg substitute may be from about 5.5 to 6, 5.5 to 6.5, 5.5 to 7, 5.5 to 7.5, 5.5 to 8, 5.5 to 8.5, 5.5 to 9, 6 to 6.5, 6 to 7, 6 to 7.5, 6 to 8, 6 to 8.5, 6 to 9, 6.5 to 7, 6.5 to 7.5, 6.5 to 8, 6.5 to 8.5, 6.5 to 9, 7 to 7.5, 7 to 8, 7 to 8.5, 7 to 8, 7.5 to 8, 7.5 to 8.5, or 7.5 to 9. In an example, the pH of the egg-like product or egg substitute is from 6 to 8.

The food product may be a milk (e.g., milk-like product) or a milk product (e.g., cream, half-and-half). The milk or milk product may be a comminuted oilseed material that has been hydrated. The milk or milk product (e.g., milk substitute) comprise greater than or equal to about 5%, 10%, 15%, 20%, 25%, 30%, 40%, 50%, 60%, 70%, 80%, 90%, 95%, or more oilseed material. The milk or milk product may comprise between about 5% and 10%, 5% and 15%, 5% and 20%, 5% and 25%, 5% and 30%, 5% and 40%, 5% and 50%, 5% and 60%, 5% and 70%, 5% and 80%, 5% and 90%, or 5% and 95% oilseed material. In an example, the oilseed material comprises squash seeds. In another example, the oilseed material comprises sunflower or rape seeds. In an example, the milk product comprises at least 5% whole oilseed material. In another example, the milk product comprises at least 10% whole oilseed material. The milk or milk product may comprise insoluble particles, such as fibers or proteins. For example, the milk or milk product may comprise aggregated insoluble proteins. The milk or milk product (e.g., a plant-based milk replica or substitute) may comprise between about 1% and 40% insoluble material by weight. Alternatively, or in addition to, a portion of or all of the insoluble may be removed such that the milk or milk product comprises less than or equal to about 40%, 35%, 30%, 25%, 20%, 15%, 10%, 5%, 2%, or less insoluble material by weight. Alternatively, or in addition to, the product may be a whole product and may contain all originally present insoluble material. The milk or milk product may further comprise plant, microorganisms, microorganism complexes (e.g., multicellular fungus), or derivatives thereof, nitrogen and carbons sources for the microorganisms, flavoring agents, gelling agents, thickening agents, coagulating agents, sweetening agents, fats and oils, butters, protein isolates, protein powders, mineral supplements, preservatives, spices, herbs, animal-based products, or any combination thereof. The milk product may be fermented with microorganisms for a duration to modify the flavor, texture, color, and/or macronutrient (e.g., proteins, carbohydrates, etc.) content. The milk product may be periodically fermented. For example, the milk product may be fermented for greater than or equal to 5 minutes, 10 minutes, 20 minutes, 30 minutes, 40 minutes, 60 minutes, 1.5 hours, 2 hours, 3 hours, 4 hours, 6 hours, 8 hours, 10 hours, or more. The milk product may be fermented greater than or equal to 1, 2, 3, 4, 5, 6, 8, 10, or more times. Each periodic fermentation cycle may be the same or may be different. For example, the milk product may be fermented at least once for a short time period (e.g., less than 4 hours) with one type or types of microorganisms and fermented at least once for a longer time (e.g., greater than 4 hours with other types of microorganisms. Microorganisms may be any microorganisms described elsewhere herein. The cultures may be alive or dead in the final product. The cultures may be killed between periodic fermentation cycles.

The milk product may further comprise protein. The protein may be provided from the oilseed material. Alternatively, or in addition to, the protein may be an additional ingredient such as a protein isolate or protein powder. The protein isolate may be a grain protein isolate, seed protein isolate, legume protein isolate, vegetable protein isolate, fungal protein isolate, or any combination thereof. In an example, the protein isolate is a legume protein isolate. In another example, the protein isolate is a grain protein isolate. In another example, the protein isolate is a seed protein isolate. Alternatively, or in addition to, the protein isolate may be a lab grown protein source (e.g., from synthetically grown muscle tissue, egg protein, or other animal based cell). The added protein may also be a protein concentrate, a crude protein, or protein flour. The protein isolate, protein concentrate, or crude protein may be derived from a seed, grain, or fungal source. In an example, the protein may comprise greater than or equal to about 1%, 2%, 5%, 8%, 10%, 15%, 20%, 30%, 40%, 50% or more seed material by mass. In another example, the protein may comprise greater than or equal to about 1%, 2%, 5%, 8%, 10%, 15%, 20%, 30%, 40%, 50% or more legumes, nuts, grains, or fatty fruit by mass. The added protein may be provides to the food product as a powder, flour, or moist composition. In an example, the added protein is derived from a lab grown source such as a fungal culture, bacterial culture, or synthetically produced animal cell (e.g., lab grown muscle tissue, egg protein, or other animal-type cell). The added protein may be emulsified with an oil and/or a gelling agent.

The milk product may have greater than or equal to about 1%, 2%, 3%, 4%, 5%, 6%, 8%, 10%, 12%, 15%, 20%, 25%, 30%, 40%, 50%, 60%, 70%, 80%, 90%, or more protein by caloric value. The milk product may have from about 1% to 2%, 1% to 2%, 1% to 3%, 1% to 4%, 1% to 5%, 1% to 6%, 1% to 8%, 1% to 10%, 1% to 15%, 1% to 20%, 1% to 25%, 1% to 30%, 1% to 40%, 1% to 50%, 1% to 60%, 1% to 70%, 1% to 80%, 1% to 90%, 2% to 3%, 2% to 4%, 2% to 5%, 2% to 6%, 2% to 8%, 2% to 10%, 2% to 15%, 2% to 20%, 2% to 25%, 2% to 30%, 2% to 40%, 2% to 50%, 2% to 60%, 2% to 70%, 2% to 80%, 2% to 80%, 3% to 4%, 3% to 5%, 3% to 6%, 3% to 8%, 3% to 10%, 3% to 15%, 3% to 20%, 3% to 25%, 3% to 30%, 3% to 40%, 3% to 50%, 3% to 60%, 3% to 70%, 3% to 80%, 3% to 90%, 4% to 5%, 4% to 6%, 4% to 8%, 4% to 10%, 4% to 15%, 4% to 20%, 4% to 25%, 4% to 30%, 4% to 40%, 4% to 50%, 4% to 60%, 4% to 70%, 4% to 80%, 4% to 90%, 5% to 6%, 5% to 8%, 5% to 10%, 5% to 15%, 5% to 20%, 5% to 25%, 5% to 30%, 5% to 40%, 5% to 50%, 5% to 60%, 5% to 70%, 5% to 80%, 5% to 90%, 6% to 8%, 6% to 10%, 6% to 15%, 6% to 20%, 6% to 25%, 6% to 30%, 6% to 40%, 6% to 50%, 6% to 60%, 6% to 70%, 6% to 80%, 6% to 90%, 8% to 10%, 8% to 15%, 8% to 20%, 8% to 25%, 8% to 30%, 8% to 40%, 8% to 50%, 8% to 60%, 8% to 70%, 8% to 80%, 8% to 90%, 10% to 15%, 10% to 20%, 10% to 25%, 10% to 30%, 10% to 40%, 10% to 50%, 10% to 60%, 10% to 70%, 10% to 80%, 10% to 90%, 15% to 20%, 15% to 25%, 15% to 30%, 15% to 40%, 15% to 50%, 15% to 60%, 15% to 70%, 15% to 80%, 15% to 90%, 20% to 25%, 20% to 30%, 20% to 40%, 20% to 50%, 20% to 60%, 20% to 70%, 20% to 80%, 20% to 90%, 25% to 30%, 25% to 40%, 25% to 50%, 25% to 60%, 25% to 70%, 25% to 80%, 25% to 90%, 30% to 40%, 30% to 50%, 30% to 60%, 30% to 70%, 30% to 80%, 30% to 90%, 40% to 50%, 40% to 60%, 40% to 70%, 40% to 80%, 40% to 90%, 50% to 60%, 50% to 70%, 50% to 80%, 50% to 90%, 60% to 70%, 60% to 80%, 60% to 90%, 70% to 80%, 70% to 90%, or 80% to 90% protein by caloric value. In an example, the milk product comprises greater than 8% protein by caloric value. In another example, the milk product comprises from about 8% to 60% protein by caloric value.

The food product may be a yogurt or fermented product. The yogurt or fermented product may be formed from the milk or milk product. The milk product may be fermented to form the yogurt or fermented product. The yogurt or fermented product may comprise active or live cultures. The live cultures may be probiotic cultures. The live cultures may include yeast, fungal, or bacterial cultures. Alternatively, or in addition to, the yogurt or fermented product may be pasteurized and may not comprise live cultures (e.g., cultures are dead cultures). The yogurt or fermented product may be yogurt, double strained yogurt, triple strained yogurt, kefir, sour cream, buttermilk, lassi, leben, labneh, or any other fermented milk-based product. The yogurt or fermented product may further comprise one or more of plants, microorganisms, microorganism complexes (e.g., multicellular fungus), or derivatives thereof, flavoring agents, gelling agents, thickening agents, coagulating agents, sweetening agents, fats and oils, protein isolates, protein powders, mineral supplements, preservatives, spices, herbs, animal-based products, or any combination thereof.

The food product may be a tofu-like or tofu-replica product. The tofu-like or tofu-replica product may be formed from the milk or milk product. The milk product may be curdled to form the tofu-like product. The tofu-like product may comprise greater than or equal to about 10%, 15%, 20%, 25%, 30%, 40%, 50%, 60%, 70%, 80%, 90%, 95%, or more oilseed material. The tofu-like product may comprise between about 10% and 15%, 10% and 20%, 10% and 25%, 10% and 30%, 10% and 40%, 10% and 50%, 10% and 60%, 10% and 70%, 10% and 80%, 10% and 90%, or 10% and 95% oilseed material. In an example, the oilseed material is a squash seed and the tofu-like product comprises at least 20% squash seed by weight. The tofu-like product may further comprise one or more of plants, microorganisms or derivatives thereof, flavoring agents, gelling agents, thickening agents, coagulating agents, hydrocolloids, sweetening agents, fats and oils, protein isolates, protein powders, mineral supplements, preservatives, spices, herbs, animal-based products, or any combination thereof.

The food product may be a cheese-like or cheese replica product. The cheese replica may not be derived from an animal, but may have one or more properties (e.g., nutritional value, protein content, texture, mouthfeel, etc.) that are similar, identical or substantially identical to cheese derived from an animal. For example, the cheese replica has the consistency or taste of chevre, camembert, mozzarella, cheddar, gouda, gorgonzola, blue, cream cheeses, or cheese cake type cheeses. The cheese replica may have a protein content that is within 50%, 40%, 30%, 20%, 10%, or 5% of a protein content of animal-derived cheese. The cheese product may be formed from the milk product. The milk product may be curdled to form the cheese product. The cheese product may comprise greater than or equal to about 10%, 15%, 20%, 25%, 30%, 40%, 50%, 60%, 70%, 80%, 90%, 95%, or more oilseed material. The cheese product may comprise between about 10% and 15%, 10% and 20%, 10% and 25%, 10% and 30%, 10% and 40%, 10% and 50%, 10% and 60%, 10% and 70%, 10% and 80%, 10% and 90%, or 10% and 95% oilseed material. In an example, the oilseed material is a squash seed and the cheese product comprises at least 20% squash seed by dry weight. In another example, the oilseed material is a sunflower seed and the cheese product comprises at least 20% sunflower seed by dry weight. The cheese product may comprise active or live cultures. The live cultures may be probiotic cultures. The live cultures may include yeast, fungal, or bacterial cultures. Alternatively, or in addition to, the cheese product may be pasteurized and may not comprise live cultures (e.g., cultures are dead cultures).The cheese product may further comprise one or more of plants, microorganisms or derivatives thereof, flavoring agents, gelling agents, thickening agents, coagulating agents, sweetening agents, fats and oils, protein isolates, protein powders, mineral supplements, preservatives, spices, herbs, animal-based products, or any combination thereof.

The cheese product may be a fresh, soft, semi-soft, or firm cheese. A fresh cheese may be a naturally curdled cheese. The naturally curdled cheese may undergo fermentation to alter the flavor and/or texture profile to create a fresh cheese replica. The fresh cheese may have a moisture content of greater than or equal to about 60%, 65%, 70%, 75%, 80%, or greater. The fresh cheese may have a moisture content between 60% and 65%, 60% and 70%, 60% and 55%, or 60% and 80%. In an example, the cheese product is a fresh cheese and has a moisture content of greater than or equal to 60% by weight. The fresh cheese product may be a feta, queso fresco, cotija, mozzarella, oaxaca, panela, halloumi, paneer, farmer's cheese, queso blanco, crème fraiche, fromage blac, ricotta, mascarpone, gournay cottage cheese, quarch, chèvre, or any other soft cheese replica. The soft cheese product may have a moisture content of between about 20% and 30%, 30% and 40%, 40% and 50%, 50% and 52%, 50% and 55%, 50% and 57%, 50% and 60%, 60% and 70% or 70% and 75%. In an example, the cheese product is a soft cheese product and has a moisture content of between about 50% and 60% by weight. A soft cheese product may be a havarti, munster, port salut, brie, camembert, cream cheese, gorgonzola, Neufchatel, livard, or any other type of soft cheese replica. The semi-soft cheese product may have a moisture content between about 30% and 35%, 35% and 45%, 45% and 46%, 45% and 47%, 45% and 48%, 45% and 49%, or 45% and 50%. In an example, the cheese product is a semi-soft cheese product and has a moisture content between about 45% and 50% by weight. The semi-soft cheese product may be a mozzarella, oka, lappi, jack, port salut, saint paulin, or any other semi-soft cheese replica. The firm cheese product may have a moisture content between about 10% and 20%, 20% and 25%, 25% and 30%, 30% and 35%, 35% and 36%, 35% and 37%, 35% and 38%, 35% and 39%, 35% and 40%, 35% and 41%, 35% and 42%, 35% and 43%, 35% and 44%, 35% and 45%, or 45% and 50%. In an example, the cheese product is a firm cheese product and has a moisture content of between about 35% and 45%. The firm cheese may be a cheddar (e.g., a cheddar-like product), parmesan, blue cheese, pecorino, romano, swiss, gouda, doolin, grana, gruyere, or any other hard cheese replica.

The cheese product may further comprise protein. The protein may be provided from the oilseed material. Alternatively, or in addition to, the protein may be an additional ingredient such as a protein isolate or protein powder. The protein isolate may be a grain protein isolate, seed protein isolate, legume protein isolate, vegetable protein isolate, fungal protein isolate, or any combination thereof. In an example, the protein isolate is a legume protein isolate. In another example, the protein isolate is a seed protein isolate. In another example, the protein isolate is a vegetable protein isolate. Alternatively, or in addition to, the protein isolate may be a lab grown protein source (e.g., from synthetically grown muscle tissue, egg, or other animal based cell). The added protein may also be a protein concentrate or a crude protein. The protein isolate, protein concentrate, or crude protein may be derived from a seed, grain, or fungal source. In an example, the protein may comprise greater than or equal to about 1%, 2%, 5%, 8%, 10%, 15%, 20%, 30%, 40%, 50% or more seed material by mass. In another example, the protein may comprise greater than or equal to about 1%, 2%, 5%, 8%, 10%, 15%, 20%, 30%, 40%, 50% or more legumes, nuts, grains, or fatty fruit by mass. The added protein may be provides to the food product as a powder, flour, or moist composition. In an example, the added protein is derived from a lab grown source such as a fungal culture, bacterial culture, or synthetically produced animal cell (e.g., lab grown muscle tissue, egg protein, or other animal-type cell). The added protein may be emulsified with an oil and/or a gelling agent.

The cheese product may have greater than or equal to about 1%, 2%, 3%, 4%, 5%, 6%, 8%, 10%, 12%, 15%, 20%, 25%, 30%, 40%, 50%, 60%, 70%, 80%, 90%, or more protein by caloric value. The cheese product may have from about 1% to 2%, 1% to 2%, 1% to 3%, 1% to 4%, 1% to 5%, 1% to 6%, 1% to 8%, 1% to 10%, 1% to 15%, 1% to 20%, 1% to 25%, 1% to 30%, 1% to 40%, 1% to 50%, 1% to 60%, 1% to 70%, 1% to 80%, 1% to 90%, 2% to 3%, 2% to 4%, 2% to 5%, 2% to 6%, 2% to 8%, 2% to 10%, 2% to 15%, 2% to 20%, 2% to 25%, 2% to 30%, 2% to 40%, 2% to 50%, 2% to 60%, 2% to 70%, 2% to 80%, 2% to 80%, 3% to 4%, 3% to 5%, 3% to 6%, 3% to 8%, 3% to 10%, 3% to 15%, 3% to 20%, 3% to 25%, 3% to 30%, 3% to 40%, 3% to 50%, 3% to 60%, 3% to 70%, 3% to 80%, 3% to 90%, 4% to 5%, 4% to 6%, 4% to 8%, 4% to 10%, 4% to 15%, 4% to 20%, 4% to 25%, 4% to 30%, 4% to 40%, 4% to 50%, 4% to 60%, 4% to 70%, 4% to 80%, 4% to 90%, 5% to 6%, 5% to 8%, 5% to 10%, 5% to 15%, 5% to 20%, 5% to 25%, 5% to 30%, 5% to 40%, 5% to 50%, 5% to 60%, 5% to 70%, 5% to 80%, 5% to 90%, 6% to 8%, 6% to 10%, 6% to 15%, 6% to 20%, 6% to 25%, 6% to 30%, 6% to 40%, 6% to 50%, 6% to 60%, 6% to 70%, 6% to 80%, 6% to 90%, 8% to 10%, 8% to 15%, 8% to 20%, 8% to 25%, 8% to 30%, 8% to 40%, 8% to 50%, 8% to 60%, 8% to 70%, 8% to 80%, 8% to 90%, 10% to 15%, 10% to 20%, 10% to 25%, 10% to 30%, 10% to 40%, 10% to 50%, 10% to 60%, 10% to 70%, 10% to 80%, 10% to 90%, 15% to 20%, 15% to 25%, 15% to 30%, 15% to 40%, 15% to 50%, 15% to 60%, 15% to 70%, 15% to 80%, 15% to 90%, 20% to 25%, 20% to 30%, 20% to 40%, 20% to 50%, 20% to 60%, 20% to 70%, 20% to 80%, 20% to 90%, 25% to 30%, 25% to 40%, 25% to 50%, 25% to 60%, 25% to 70%, 25% to 80%, 25% to 90%, 30% to 40%, 30% to 50%, 30% to 60%, 30% to 70%, 30% to 80%, 30% to 90%, 40% to 50%, 40% to 60%, 40% to 70%, 40% to 80%, 40% to 90%, 50% to 60%, 50% to 70%, 50% to 80%, 50% to 90%, 60% to 70%, 60% to 80%, 60% to 90%, 70% to 80%, 70% to 90%, or 80% to 90% protein by caloric value. In an example, the cheese product is a soft cheese and comprises greater than or equal to about 15% protein by caloric value. In another example, the cheese product is a soft cheese product and comprises from about 15% to 50% protein by caloric value. In another example, the cheese product is thermoreversible (e.g., meltable) and/or a firm cheese and comprises greater than or equal to about 1.5% protein by caloric value. In another example, the cheese product is thermoreversible (e.g., meltable) and/or a firm cheese and comprises from about 1.5% to 90% protein by caloric value.

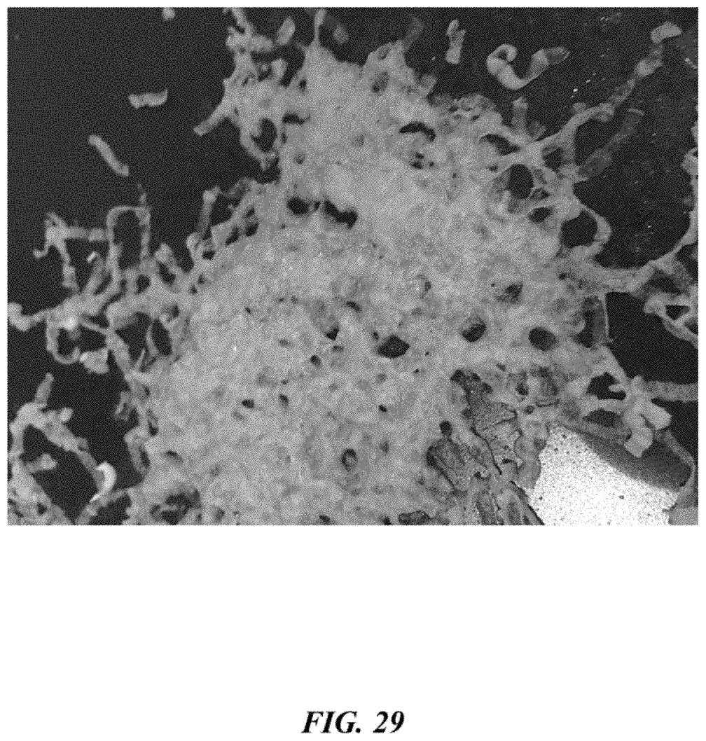

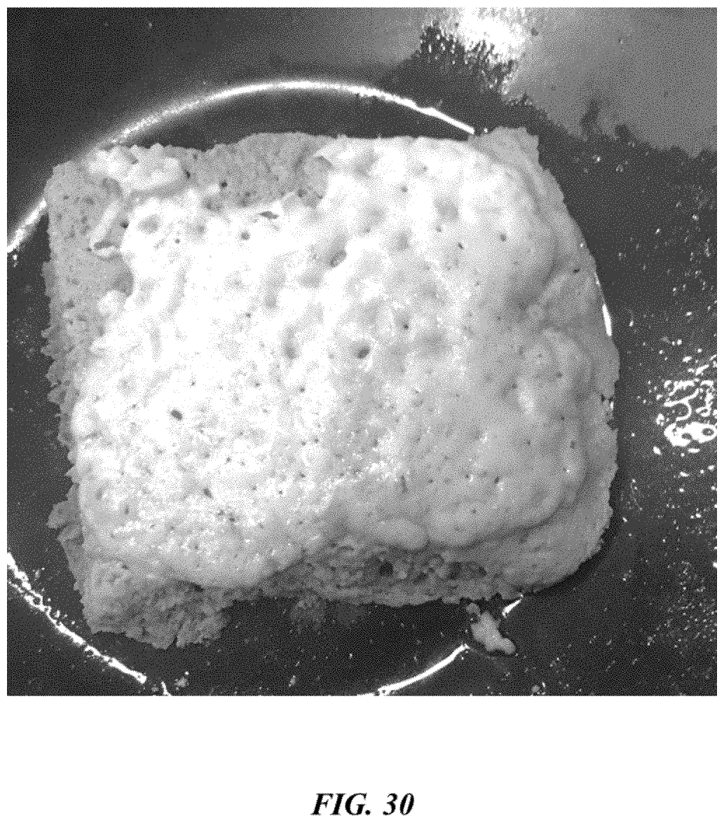

The cheese product may be a soft, firm, or hard cheese. The cheese product may be thermoreversible (e.g., meltable) or non-thermoreversible (e.g., non-meltable). The cheese product may comprise one or more starches. The starches may mimic the behavior of casein and impart stretchability to the cheese product. The starches may be plant-based starches such as vegetable starches (e.g., from potatoes, cassava, tubers, or winter squashes), legume starches (e.g., from beans, peas, lentils, etc.), and/or grain starches (e.g., from barley, corn, rice, wheat, etc.). The cheese product may comprise greater than or equal to about 2.5%, 5%, 10%, 15%, 20%, 25%, 30%, 35%, 40%, 50% or more. The cheese product may comprise from about 2.5% to 5%, 2.5% to 10%, 2.5% to 15%, 2.5% to 20%, 2.5% to 25%, 2.5% to 30%, 2.5% to 35%, 2.5% to 40%, or 2.5% to 50% starch by dry mass. The starch may permit the cheese product to be thermoreversible (e.g., to melt). Alternatively, or in addition to, the cheese product may not be thermoreverible and may be consumed as a raw cheese (e.g., without heating). The cheese product may undergo a phases change from solid or semi-solid to semi-solid or liquid, respectively, at a temperature of greater than or equal to about 30° C., 35° C., 40° C., 45° C., 50° C., 55° C., 60° C., 70° C., 80° C., or higher. In an example, the cheese replica will soften at temperatures greater than or equal to about 30° C. In another example, the cheese replica may begin to soften at a temperature greater than or equal to about 30° C. and will undergo a phase transition at temperature greater than or equal to about 50° C. The cheese product may undergo a phase change from solid or semi-solid to semi-solid or liquid, respectively, at a temperature from about 30° C. to 35° C., 30° C. to 40° C., 30° C. to 45° C., 30° C. to 50° C., 30° C. to 55° C., 30° C. to 60° C., 30° C. to 70° C., or 30° C. to 80° C. FIGS. 29 and 30 show images of thermoreversible cheeses during and after the melting process, respectively. The thermoreversible cheese replica may be thermoreversible for a select number of melting and solidification cycles. For example, the thermoreversible cheese may melt once, solidify, and then not melt again at a raised temperature. The thermoreversible cheese replica may be thermoreversible for greater than or equal to 1, 2, 3, 4, 5, 6, 8, 10, 15, 20, 30, 40, 50, 100, or more melting and solidification cycles (e.g., via thermal cycling of the cheese replica).

Microorganism may include one or more fungi, yeast, and/or bacteria. The fungi, yeast, and/or bacteria may include one or more of Arthrobacter arilaitensis, Arthrobacter bergerei, Arthrobacter globiformis, Arthrobacter nicotianae, Arthrobacter variabilis, Bifidobacterium adolescentis, Bifidobacterium animalis, Bifidobacterium bifidum, Bifidobacterium breve, Bifidobacterium infantis, Bifidobacterium lactis, Bifidobacterium longum, Bifidobacterium pseudolongum, Bifidobacterium thermophilum, Brachybacterium alimentarium, Brachybacterium tyrofermentans, Brevibacterium aurantiacum, Brevibacterium casei, Brevibacterium linens, Candida colliculosa, Candida kefyr, Candida krusei, Candida mycoderma, Candida utilis, Candida vini, Candida zeylanoides, Carnobacterium divergens, Carnobactrium maltaromaticum, Corynebacterium ammoniagenes, Corynebacterium casei, Corynebacterium flavescens, Corynebacterium mooreparkense, Corynebacterium variabile, Cystofilobasidium infirmominiatum, Debaryomyces hansenii, Debaryomyces kloeckeri, Enterococcus faecalis, Fusarium domesticum, Geotrichum candidum, Hafnia alvei, Issatchenkia orientalis, Kazachstania exigua, Kazachstania unispora, Kluyveromyces lactis, Kluyveromyces marxianus, Kocuria rhizophila, Kocuria varians, Lactobacillus acidipiscis, Lactobacillus acidophilus, Lactobacillus brevis, Lactobacillus bulgaricus, Lactobacillus casei, Lactobacillus coryniformis, Lactobacillus curvatus, Lactobacillus delbrueckii, Lactobacilus fermentum, Lactobacillus gasseri, Lactobacillus johnsonii, Lactobacillus kefiranofaciens, Lactobacillus kefiri, Lactobacillus nodensis, Lactobacillus parabrevis, Lactobacillus paracasei, Lactobacillus parakefiri, Lactobacillus paraplantarum, Lactobacillus pentosus, Lactobacillus perolents, Lactobacillus planarum, Lactobacillus rhamnosus, Lactobacillus salivarius, Lactobacillus tucceti, Lactococcus lactis, Lactococcus raffinolactis, Lecanicillium lecanii, Leuconostoc citreum, Leuconostoc pseudomesenteroides, Leuconostoc kimchi, Leuconostoc mesenteroides, Macrococcus caseolyticus, Microbacterium foliorum, Microbacterium gubbeenense, Micrococcus luteus, Mucor racemosus, Penicillium album, Penicillium camemberti, Penicillium caseifulvum, Penicillium chrysogenum, Penicillium commune, Penicillium nalgiovense, Penicillium roqueforti, Pichia fermentans, Propionibacterium acidipropionici, Propionibacterium freudenreichii, Propionibacterium jensenii, Proteus vulgaris, Pseudomonas fluorescens, Psychrobacter celer, Rhodosporidium infirmominiatum, Rhodotorula minuta, Saccharomyces cerevisiae, Staphylococcus carnosus, Staphylococcus equorum, Staphylococcus fieurettii, Staphylococcus saphrophyticus, Staphylococcus sciuri carnaticus, Staphylococcus succinus, Staphylococcus vitulinus, Staphylococcus xylosus, Streptococcus thermophilus, Streptococcus gallolyticus, Streptococcus salivarius, Tetragenococcus delbrueckii, Thrichosporon beigelii, Verticillium lecanii, Yarrowia lipolytica, and Zygotorulaspora florentina.

The microorganisms may add flavor, induce curdling, or ferment the plant-based food product. The actions of the microorganisms may induce a color change in the food product. The color change may be induced by degradation of phenolic and other pigmented molecular compounds. The microorganisms may metabolize the phenolic and other pigmented (e.g., colorizing) compounds within the food product to alter the color of the food product. For example, a plant-based food product that has a grey, green, yellow, or brown color may be further fermented to generate a white or off-white color. Alternatively, the product may be fermented to generate a reduction in color. For example, the product may reduce in color from grey to a lighter grey. The white pigment of the food product may fully reflect and scatter substantially all visible wavelengths of light. Off-white color pigments may be slightly grey or yellow. Off-white food product may reflect and scatter greater than or equal to 99%, 98%, 97%, 96%, 95%, 94%, 93%, 92%, 91%, or 90%, %, 89%, 88%, 87%, 86%, 85%, 84%, 83%, 82%, 81%, 80%, 79%, 78%, 77%, 76%, 75%, 74%, 73%, 72%, 71%, 70%, 69%, 68%, 67%, 66%, 65%, 64%, 63%, 63%, 61%, 60% or less, and not including 100% reflectance. Microorganisms that reduce pigments within the food product may include, include, but are not limited to Arthrobacter arilaitensis, Arthrobacter bergerei, Arthrobacter globiformis, Arthrobacter nicotianae, Arthrobacter variabilis, Bifidobacterium adolescentis, Bifidobacterium animalis, Bifidobacterium bifidum, Bifidobacterium breve, Bifidobacterium infantis, Bifidobacterium lactis, Bifidobacterium longum, Bifidobacterium pseudolongum, Bifidobacterium thermophilum, Brachybacterium alimentarium, Brachybacterium tyrofermentans, Brevibacterium aurantiacum, Brevibacterium casei, Brevibacterium linens, Candida colliculosa, Candida kefyr, Candida krusei, Candida mycoderma, Candida utilis, Candida vini, Candida zeylanoides, Carnobacterium divergens, Carnobactrium maltaromaticum, Corynebacterium ammoniagenes, Corynebacterium casei, Corynebacterium flavescens, Corynebacterium mooreparkense, Corynebacterium variabile, Cystofilobasidium infirmominiatum, Debaryomyces hansenii, Debaryomyces kloeckeri, Enterococcus faecalis, Fusarium domesticum, Geotrichum candidum, Hafnia alvei, Issatchenkia orientalis, Kazachstania exigua, Kazachstania unispora, Kluyveromyces lactis, Kluyveromyces marxianus, Kocuria rhizophila, Kocuria varians, Lactobacillus acidipiscis, Lactobacillus acidophilus, Lactobacillus brevis, Lactobacillus bulgaricus, Lactobacillus casei, Lactobacillus coryniformis, Lactobacillus curvatus, Lactobacillus delbrueckii, Lactobacilus fermentum, Lactobacillus gasseri, Lactobacillus johnsonii, Lactobacillus kefiranofaciens, Lactobacillus kefiri, Lactobacillus nodensis, Lactobacillus parabrevis, Lactobacillus paracasei, Lactobacillus parakefiri, Lactobacillus paraplantarum, Lactobacillus pentosus, Lactobacillus perolents, Lactobacillus planarum, Lactobacillus rhamnosus, Lactobacillus salivarius, Lactobacillus tucceti, Lactococcus lactis, Lactococcus raffinolactis, Lecanicillium lecanii, Leuconostoc citreum, Leuconostoc pseudomesenteroides, Leuconostoc kimchi, Leuconostoc mesenteroides, Macrococcus caseolyticus, Microbacterium foliorum, Microbacterium gubbeenense, Micrococcus luteus, Mucor racemosus, Penicillium album, Penicillium camemberti, Penicillium caseifulvum, Penicillium chrysogenum, Penicillium commune, Penicillium nalgiovense, Penicillium roqueforti, Pichia fermentans, Propionibacterium acidipropionici, Propionibacterium freudenreichii, Propionibacterium freudenreichii ssp. shermaii, Propionibacterium jensenii, Proteus vulgaris, Pseudomonas fluorescens, Psychrobacter celer, Rhodosporidium infirmominiatum, Rhodotorula minuta, Saccharomyces cerevisiae, Staphylococcus carnosus, Staphylococcus equorum, Staphylococcus fieurettii, Staphylococcus saphrophyticus, Staphylococcus sciuri carnaticus, Staphylococcus succinus, Staphylococcus vitulinus, Staphylococcus xylosus, Streptococcus thermophilus, Streptococcus gallolyticus, Streptococcus salivarius, Tetragenococcus delbrueckii, Thrichosporon beigelii, Verticillium lecanii, Yarrowia lipolytica, and Zygotorulaspora florentina.

The plant-based food product may contain plant-derived flours. The plant-based food product may comprise less than or equal to about 40%, 35%, 30%, 25%, 20%, 15%, 12%, 10%, 8%, 6%, 4%, 2%, 1% or less plant-derived flours by weight. The plant-based food product may contain a single type of flour or multiple types of flour. The flour may include, but is not limited to, one or more of wheat flour, rice flour, corn flour, corn gluten, corn bran, corn starch, barley flour, sorghum flour, oat flour, potato flour, rye flour, tapioca starch, cassava starch, bacterial or fungus derived or produced starch, konjac, seaplant derived starch, or any combinations thereof. The plant-derived flour may be a high protein flour. A high protein flour may have greater than or equal to 5%, 10%, or 15% protein by caloric value.

The plant-based food product may contain one or more plant-derived and/or non-plant derived oils. The plant-based food product may comprise less than or equal to about 60%, 50%, 40%, 30%, 20%, 15%, 12%, 10%, 8%, 6%, 4%, 2%, 1% or less added oils by weight. The plant-based food product may contain a single type of added oil or multiple types of added oil. The added oil may include vegetable oil, palm fruit oil, coconut oil (e.g., solid or liquid), cottonseed oil, mango oil, rice bran oil, flaxseed oil, canola oil, olive oil, soybean oil, sunflower oil, safflower oil, wheat oil, corn oil, barley oil, fish oil, grain oil, legume oil, seed oil, nut oil, fruit oil, cacao oil, cocoa butter, microorganism (e.g., fungal, bacterial, or algal) derived or produced oils , or any combinations thereof.

The plant-based food product may contain one or more flavoring agents. A flavoring agent may be a flavoring molecule or a flavoring precursor that combines with another material to generate a flavor. Flavoring agents may include protein powders, cocoa powder, tea powders, coffee powders, legumes, grains, nuts or nut butters, chocolate, isolated molecular compounds, partially isolated molecular compounds, bacterial or fungus or seaplants in whole, derivatives, or by products thereof, plants or plant extracts or derivatives, or any combination thereof. The flavoring agents may additionally comprise one or more salts. Salts may include sodium chloride, calcium sulfate, magnesium sulfate, calcium chloride, potassium chloride, or any combination thereof. Flavoring agents can include spices, herbs vinegars, herbs, extracts, fruit juices, artificial flavoring or compounds, other plant, fungus, or bacteria matter, and the like. In an example, the plant-based food product comprises jalapenos, garlic, sea salt, fruit juice, and other herbs as flavoring agents.

Flavoring molecules and flavoring precursors may include carbohydrates and sugars, nucleotides and nucleosides, free fatty acids, amino acids and amino acid isolates, vitamins and minerals, antioxidants, or any combination thereof. Carbohydrates and sugars may include, but are not limited to, glucose, fructose, ribose, sucrose, arabinose, inositol, maltose, molasses, maltodextrin, glycogen, glycol, galactose, lactose, ribitol, amylose, amylopectin, xylose, or any combination thereof. Nucleotides and nucleosides may include, but are not limited to, inosine, inosine monophosphate, guanosine, guanosine monophosphate, adenosine, adenosine monophosphate, or any combination thereof. Free fatty acids may include, but are not limited to, arachidic acid, behenic acid, caprylic acid, capric acid, cerotic acid, erucic acid, lauric acid, linoleic acid, myristic acid, palmitic acid, palmitoleic acid, stearic acid, lignoceric acid, and any combination thereof. Amino acids and amino acid isolates may include, but are not limited to, cysteine, cystine, cysteine sulfoxide, allicin, selenocystein, methionine, isoleucine, leucine, lysine, phenylalanine, threonine, tryptophan, 5-hydroxytriptophan, valine, arginine, histidine, alanine, asparagine, aspartate, glutamate, glutamine, glycine, proline, serine, tyrosine, taurine, or any combination thereof.

The plant-based food product may include one or more vitamins, minerals, and/or supplements. Vitamins and minerals may include, but are not limited to retinol, retinal, beta-carotene, thiamine, riboflavin, niacin, niacinamide, nicotinamide, riboside, pantothenic acid, pyridoxine, pyridoxamine, pyridoxal, biotin, folates, cyanocobalamin, hydroxocobalamin, methylcobalamin, adenosylcobalamin, ascorbic acid, cholecalciferol, ergocalciferol, tocopherols (e.g., alpha-tocopherol), tocotrienols, phylloquinone, menaquinones, potassium, chlorine, sodium, calcium, phosphorus, magnesium, iron, zinc, manganese, copper, iodine, chromium, molybdenum, selenium, cobalt, or any combination thereof. Vitamin and mineral supplements may further include taurine, carnitine, sodium ascorbate, vitamin A acetate, vitamin B12, vitamin D-3, vitamin E, beta-carotene, choline chloride, d-calcium pantothenate, folic acid, menodione sodium bisulfite complex, niacin supplement, pyridoxine hydrochloride, riboflavin supplement, thiamine minonitrate, calcium carbonate, calcium citrate, calcium iodate, cobalt carbonate, cobalt proteinate, copper proteinate, copper sulfate, ferrous sulfate, iron proteinate, manganese proteinate, manganese sulfate, potassium chloride, sodium selenite, zinc oxide, zinc proteinate, zinc sulfate, or any combination thereof. Preservatives may include, but are not limited to, butylated hydroxyanisole, butylated hydroxytoluene, ethoxyquin, rosemary extract, sodium propionate, vitamin E, or any combination thereof. Antioxidants may include, but are not limited to, beta-carotene, alpha-tocopherol, caffeic acid, propyl gallate, epigallocatechin gallate, or any combination thereof. Nutritional supplements may include, but are not limited to curcumin, docosahexaenoic acid, beta-carotene, phenolic compounds, antioxidants, etc. The vitamin, mineral, and nutritional supplements may be synthetically or naturally derived. The vitamin, mineral, and nutritional supplements may be purified or may not be purified.

The plant-based food product may contain one or more organic acids. The organic acids may preserve the food product. The organic acids may alter the taste or flavor profile of the food product. The organic acids may be plant derived acids, microorganism derived acids, or animal derived acids. The organic acids may include, but are not limited to, lactic acid, glycolic acid, tricarboxylic acids (e.g., citric acid), dicarboxylic acids (e.g., succinic acid or tartaric acid), sorbic acid, caffeic acid, benzoic acid, malic acid, propionic acid, acetic acid, or any combination thereof.

The plant-based food product may comprise one or more spices. Spices may include liquid smoke, pepper, allspice, caraway, cardamom, celery seed, cinnamon, cloves, coriander, cream of tartar, cumin, curing salt, dill seed, fennel seed, garlic, horseradish, lemon peel, mustard seed, onion, saffron, sesame seed, sumac, turmeric, vanilla extract, wasabi, or any combination thereof.

The plant-based food product may comprise one of more of gelling agents (e.g., thickening agents), coagulating agents, emulsifying agents, or stabilizing agents. A single gelling agent may be added to the product of multiple gelling agents may be added to the product. The gelling agent may be one or more of natural gums, starches (e.g., tapioca starch, konjac, or inulin), pectin, gellan gum, guar gum, agar-agar, acacia gum, xanthan gum, carrageenan, irish sea moss, gelatin, alginic acid, sodium alginate, potassium alginate, ammonium alginate, calcium alginate, locust bean gum, curdlan, or any combination thereof. Coagulating agents may include one or more of an acid (e.g., citrus juice, vinegar, tartaric acid, citric acid etc.), coagulating salt (e.g., calcium sulfate, magnesium chloride, calcium chloride, sodium chloride, potassium chloride, glucono delta-lactone, or rock salt), enzymes, or microorganisms. Coagulating enzymes may include crosslinking enzymes or proteases, such as papain or thermolysin derived from Bacillus subtilis, Aspergillus oryzae, Bacillus thermoproteolyticus, Bacillus polymyxa, Endothia parasitica, Mucor miehei, Bromelain, Endothia parasitica, Mucor miehei, Saccharomyces bayous (SCY003), or any other food safe microorganisms from the same Kingdom. The plant-based food product may further include enzymes that cross-link the food product. The crosslinking enzyme may generate crosslinks between polypeptide chains to facilitate coagulation (e.g., curd formation). The crosslinking enzyme may be a transglutaminase from a food safe microorganism. The plant-based food product may include emulsifying and stabilizing agents such as, but not limited to, gellan, inulin, konjac, carboxymethylcellulose, hydroxypropyl methylcellulose, guar gum, irish sea moss, carageenan, curdlan, agar-agar, alginate, pectin, or any emulsifying or stabilizing agent derived or produced by a plant, fungus and/or bacteria, or any combination thereof.

The plant-based food product may comprise one or more sweeteners. The sweeteners may be added to increase flavor and palatability or as a food source for microorganisms during fermentation. The plant-based food product may comprise less than or equal to about 20%, 10%, 8%, 6%, 4%, 2%, 1%, 0.5%, 0.025%, 0.01%, 0.005%, or less sweetener by weight. Sweeteners may include, but are not limited to, glucose, sucralose, sucrose, saccharin, aspartame, acesulfame potassium, neotame, steviol, agave, fruit and vegetable juices, fruit and vegetable extracts, whole fruits and vegetables, cane sugar, coconut sugar, brown sugar, stevia, erythritol, molasses, agave, coconut nectar, maple syrup, honey, or any combination thereof.

The plant-based food product may further comprise protein. The protein may be provided from the oilseed material. Alternatively, or in addition to, the protein may be an additional ingredient such as a protein isolate or protein powder. The protein isolate may be a grain protein isolate, seed protein isolate, legume protein isolate, vegetable protein isolate, fungal protein isolate, or any combination thereof. In an example, the protein isolate is a legume protein isolate. In another example, the protein isolate is a vegetable protein isolate. In another example, the protein isolate is a seed protein isolate. Alternatively, or in addition to, the protein isolate may be a lab grown protein source (e.g., from synthetically grown muscle tissue, egg protein, or other animal based cell). The added protein may also be a protein concentrate or a crude protein. The protein isolate or crude protein may be derived from a seed, grain, or fungal source. In an example, the protein may comprise greater than or equal to about 1%, 2%, 5%, 8%, 10%, 15%, 20%, 30%, 40%, 50% or more seed material by mass. In another example, the protein may comprise greater than or equal to about 1%, 2%, 5%, 8%, 10%, 15%, 20%, 30%, 40%, 50% or more legumes, nuts, grains, or fatty fruit by mass. The added protein may be provides to the food product as a powder, flour, or moist composition. In an example, the added protein is derived from a lab grown source such as a fungal culture, bacterial culture, or synthetically produced animal cell (e.g., lab grown muscle tissue, egg protein, or other animal-type cell). The added protein may be emulsified with an oil and/or a gelling agent.

The plant-based food product may have greater than or equal to about 1%, 2%, 3%, 4%, 5%, 6%, 8%, 10%, 12%, 15%, 20%, 25%, 30%, 40%, 50%, 60%, 70%, 80%, 90%, or more protein by caloric value. The plant-based food product may have from about 1% to 2%, 1% to 2%, 1% to 3%, 1% to 4%, 1% to 5%, 1% to 6%, 1% to 8%, 1% to 10%, 1% to 15%, 1% to 20%, 1% to 25%, 1% to 30%, 1% to 40%, 1% to 50%, 1% to 60%, 1% to 70%, 1% to 80%, 1% to 90%, 2% to 3%, 2% to 4%, 2% to 5%, 2% to 6%, 2% to 8%, 2% to 10%, 2% to 15%, 2% to 20%, 2% to 25%, 2% to 30%, 2% to 40%, 2% to 50%, 2% to 60%, 2% to 70%, 2% to 80%, 2% to 80%, 3% to 4%, 3% to 5%, 3% to 6%, 3% to 8%, 3% to 10%, 3% to 15%, 3% to 20%, 3% to 25%, 3% to 30%, 3% to 40%, 3% to 50%, 3% to 60%, 3% to 70%, 3% to 80%, 3% to 90%, 4% to 5%, 4% to 6%, 4% to 8%, 4% to 10%, 4% to 15%, 4% to 20%, 4% to 25%, 4% to 30%, 4% to 40%, 4% to 50%, 4% to 60%, 4% to 70%, 4% to 80%, 4% to 90%, 5% to 6%, 5% to 8%, 5% to 10%, 5% to 15%, 5% to 20%, 5% to 25%, 5% to 30%, 5% to 40%, 5% to 50%, 5% to 60%, 5% to 70%, 5% to 80%, 5% to 90%, 6% to 8%, 6% to 10%, 6% to 15%, 6% to 20%, 6% to 25%, 6% to 30%, 6% to 40%, 6% to 50%, 6% to 60%, 6% to 70%, 6% to 80%, 6% to 90%, 8% to 10%, 8% to 15%, 8% to 20%, 8% to 25%, 8% to 30%, 8% to 40%, 8% to 50%, 8% to 60%, 8% to 70%, 8% to 80%, 8% to 90%, 10% to 15%, 10% to 20%, 10% to 25%, 10% to 30%, 10% to 40%, 10% to 50%, 10% to 60%, 10% to 70%, 10% to 80%, 10% to 90%, 15% to 20%, 15% to 25%, 15% to 30%, 15% to 40%, 15% to 50%, 15% to 60%, 15% to 70%, 15% to 80%, 15% to 90%, 20% to 25%, 20% to 30%, 20% to 40%, 20% to 50%, 20% to 60%, 20% to 70%, 20% to 80%, 20% to 90%, 25% to 30%, 25% to 40%, 25% to 50%, 25% to 60%, 25% to 70%, 25% to 80%, 25% to 90%, 30% to 40%, 30% to 50%, 30% to 60%, 30% to 70%, 30% to 80%, 30% to 90%, 40% to 50%, 40% to 60%, 40% to 70%, 40% to 80%, 40% to 90%, 50% to 60%, 50% to 70%, 50% to 80%, 50% to 90%, 60% to 70%, 60% to 80%, 60% to 90%, 70% to 80%, 70% to 90%, or 80% to 90% protein by caloric value. In an example, the plant-based food product comprises greater than 5% protein by caloric value. In another example, the plant-based food product comprises from about 5% to 90% protein by caloric value.

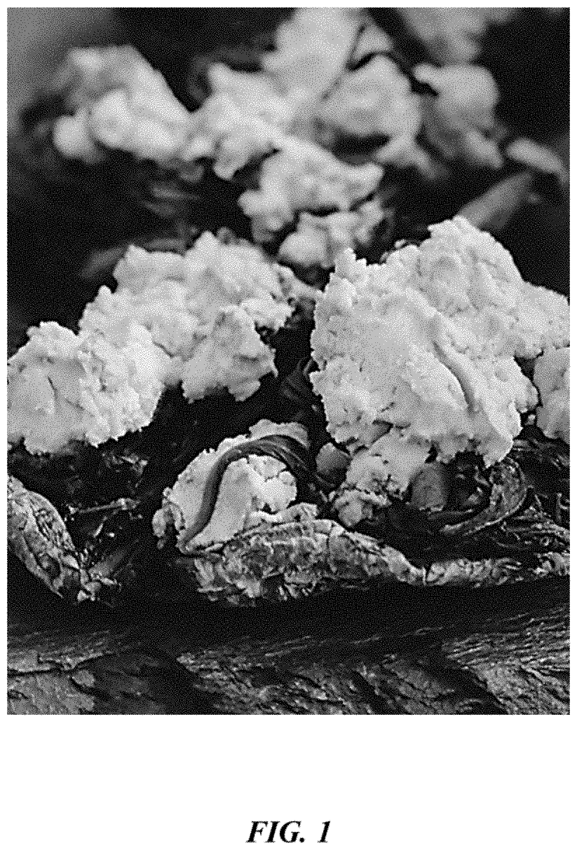

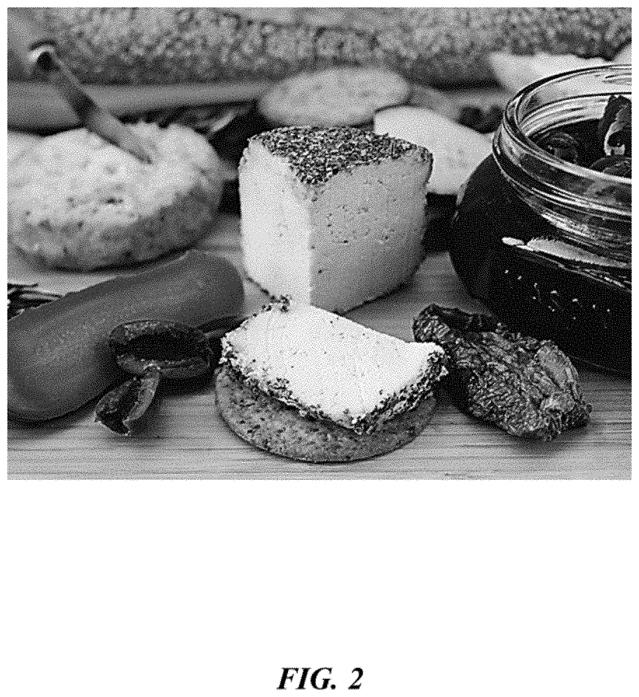

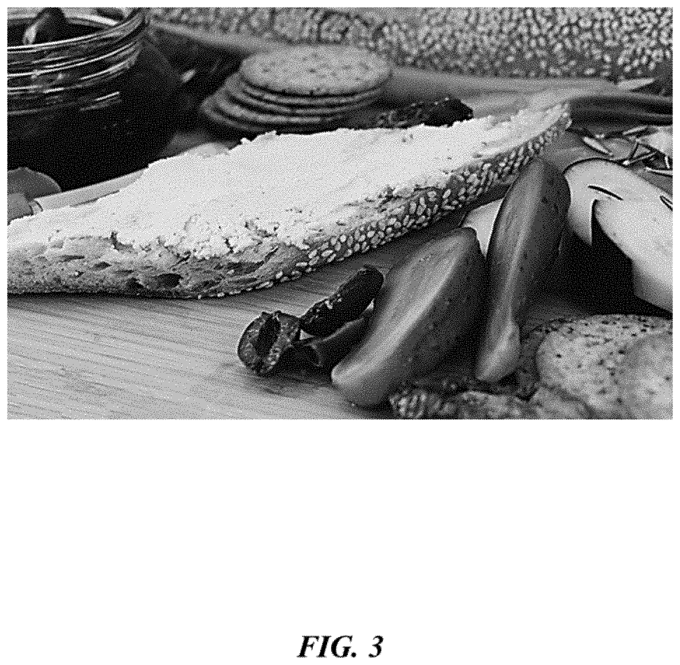

The compositions and products described herein may be consumed as a solitary product, and or, may be an ingredient added to a variety of dishes and products. For example, FIG. 1 shows an image of an example of a baked dish comprising an example ricotta cheese product atop vegetable layered Portobello mushrooms. FIG. 2 shows an image of an example of a chèvre cheese product coated with dried herbs that may be consumed as an ingredient or as a standalone product. Another example of a cheese product is show in figure FIG. 3, which shows an image of an example of a cream cheese product.

### Methods for Forming Plant-Based Food Products

In an aspect, the present disclosure provides a method for forming a plant-based food product. The plant-based food product may be formed by providing a material comprising at least about 5% squash seed material by dry weight and comminuting the material to form the plant-based food product. The plant-based food product may be used to make a variety of products including, but not limited to, milk and milk products, egg substitutes, tofu-like products, fermented beverages (e.g., kefir, leben, etc.), yogurts, buttermilk, sour cream, and cheese-like products.

In another aspect, the present disclosure provides a method for forming a plant-based fermentation product. The plant-based fermentation product may be formed by providing a material comprising at least 5% oilseed material by dry weight and fermenting the material to form the plant-base fermentation product or a reduced pigment hue from the starting pigment. Fermenting may be used to alter the flavor profile of the product to reach different objectives, such as to replicate the flavor profile of animal based products. Fermenting may be performed using one or more microorganisms that are selected to degrade phenolic and other pigmented molecular compounds. Fermenting may reduce the pigments in the plant-based fermentation product to form a white or off-white fermentation product. The plant-based fermentation product may be used to make a variety of product, including but not limited to, fermented beverages (e.g., kefir, leben, etc.), yogurts, and cheese-like products.

In another aspect, the present disclosure provides a method for forming a plant-based curd product. The plant-based curd product may be formed by providing a material with at least 10% whole oilseed material and curdling the material to form the plant-based curd product. The whole oilseed material may be an oilseed milk-like product that has not been treated to remove insoluble compounds (e.g., fibers and aggregated proteins). The plant-based curd product may be used to make a variety of products, including but not limited to, tofu-like and cheese-like products.

In another aspect, the present disclosure provides a method for forming a plant-based curd product. The plant-based curd product may be formed by providing a material with at least 10% oilseed material and curdling the material to form the plant-based curd product. The material may not comprise an isolated or purified protein (e.g., an added protein). The plant-based curd product may be used to make a variety of product, including but not limited to, tofu-like and cheese-like products.

In another aspect, the present disclosure provides a method for forming a plant-based curd product. The plant-based curd product may be formed by providing a material with at least 10% oilseed material and curdling the material to form the plant-based curd product. Curdling of the material may be performed without the use of a cross-linking enzyme. The plant-based curd product may be used to make a variety of products, including but not limited to, tofu-like, yogurt-like, milk-like, and cheese-like products.

In another aspect, the present disclosure provides a method for forming a composition comprising a plant-based product. The method may comprise providing a mixture comprising an oilseed material, subjecting the mixture to fermentation to yield a fermentation product, and using the fermentation product or a derivative thereof to form the composition comprising the plant-based product. The plant-based product may comprise (i) at least about 5% oilseed material by dry weight and (ii) from about 5% to 30% by dry weight starch, protein isolates, protein powders, or combination thereof. The plant based material may be thermoreversible and configured to undergo a phase transition from a solid phase to a semi-solid or liquid phase at a temperature of greater than or equal to 50° C.

In another aspect, the present disclosure provides a method for forming a composition comprising a plant-based product. The method may comprise providing a mixture comprising an oilseed material, subjecting the mixture to curdling to yield a plant-based curd product, and using the plant-based curd product or a derivative thereof to form the composition comprising the plant-based product. The plant-based product may comprise (i) at least about 5% oilseed material by dry weight and (ii) from about 5% to 30% by dry weight starch, protein isolates, protein powders, or combination thereof. The plant based material may be thermoreversible and configured to undergo a phase transition from a solid phase to a semi-solid or liquid phase at a temperature of greater than or equal to 50° C.

In another aspect, the present disclosure provides a method for forming a composition comprising a plant-based product. The method may comprise providing a mixture comprising an oilseed material (e.g., protein from an oilseed material or defatted oilseed material), combining the oilseed material with an oil, a gelling agent, or any combination thereof to form an oilseed mixture. The oilseed mixture may be emulsified to form a plant-based product. The plant-based product may be thermoreversible and configured to undergo a phase transition from a solid phase to a semi-solid or liquid phase at a temperature of greater than or equal to 50° C.

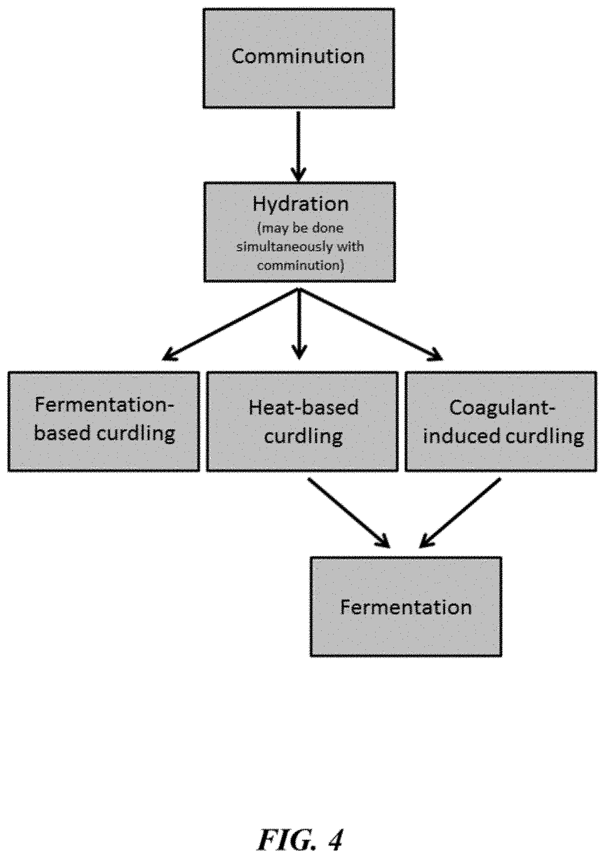

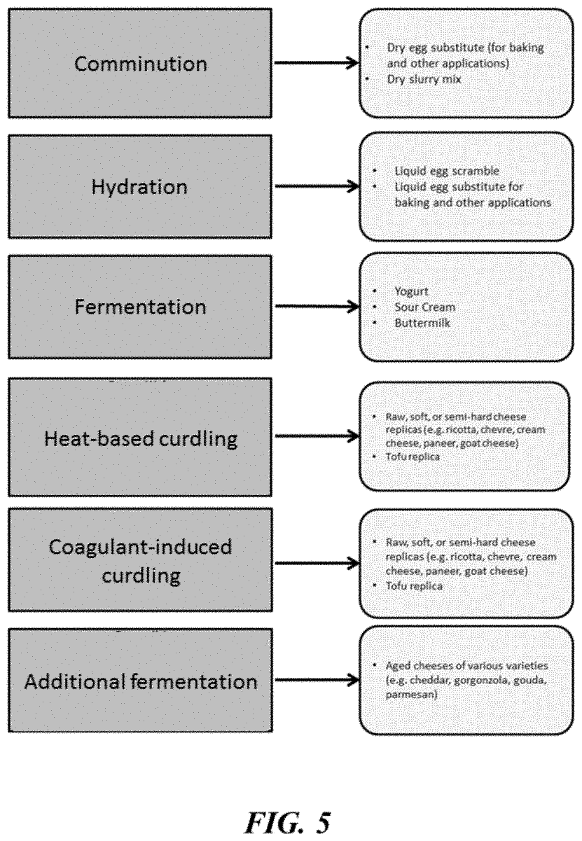

FIG. 4 schematically illustrates an example process for forming a plant-based food product. The oilseed material may be comminuted and hydrated. This may be done simultaneously or sequentially. The hydrated material may be fermented and/or curdled using heat and/or a coagulating agent. The curdled material may be fermented to form a cheese-like product. A plant-based food product may be formed at any stage of the process. For example, and as shown in FIG. 5, multiple plant-based food products (e.g., non-dairy milks, cheeses, tofu-like products, yogurt product, etc.) may be formed by the processes described herein.

The plant-based food product may be produced from an oilseed material. The oilseed material may be any oilseed material described therein. For example, the oilseed material may be one or more of safflower seed, sunflower seed, rape seed, jatropha seed, squash seed, sesame seed, groundnut, cotton seed, flax seed, hemp seed, poppy seed, chia seed, hemp seed, squash seed, soybean, peanut, mustard seed, camelina seed, or vegetable seed. The oilseed material may comprise a single type of oilseed (e.g., sunflower seed, peanut, or squash seed). Alternatively, or in addition to, the oilseed material may comprise a mixture of oilseed materials (e.g., peanut and sunflower seed or peanut, sunflower seed, and squash seed).

The oilseed material may be pre-treated to remove off-flavors and/or to remove the outer shell. Pre-treatment may include the use of activated carbon exposure, acid exposure, base exposure, steam treatment, other heating methods, toasting, deodorizing, or any combination thereof. Pre-treatment of the oilseed material may reduce the amount of insoluble components and off-flavors prior to processing the oilseed material into a plant-based food product.

The oilseed material may be soaked to soften the material. The oilseeds may be soaked in a room temperature, warm, or hot aqueous solution. The aqueous solution may have a temperature of greater than or equal to about 20° C., 25° C., 30° C., 40° C., 50° C., 60° C., 70° C., 80° C., 90° C., or higher degrees Celsius. The oilseeds may be soaked for greater than or equal to about 2 to 60 minutes. In an example, the oilseeds are soaked for 30 time in an aqueous solution of 30 degrees Celsius. The aqueous solution may comprise only water or may include soaking additives. Soaking additives may include salts, acids, or bases.

The soaked oilseed may be rinsed with a rinsing solution. The rinsing solution may be water. The temperature of the rinsing solution may be greater than or equal to about 20° C., 25° C., 30° C., 40° C., 50° C., 60° C., 70° C., 80° C., 90° C., or higher degrees Celsius. The oilseeds may be soaked for greater than or equal to about 2 minutes to 60 minutes or 60 minutes to 16 hours or more and are optionally rinsed or strained.

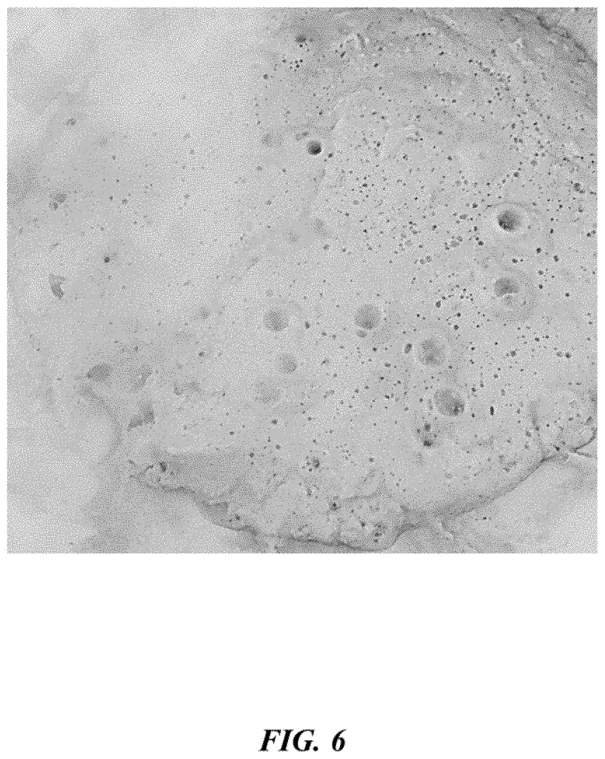

The oilseed material may be comminuted. Comminution may include grinding, chopping, pulverizing, crushing, milling, grating, blending, refining, extracting, flouring, liquefying, milking, isolating, or any other process that results in a fine particulate or powdered material. The oilseed material may be comminuted as a dry mixture or may be comminuted in the presence of water, oil, fats, salts, any food additions to the product, or other wetting agents. Oilseed materials comminuted as dry materials may form flours, powders, or granular compositions. Oilseed materials comminuted in the presence of wetting agents may form pastes, butter-like, cream-like, or slurry materials. The oilseed material may make up greater than or equal to about 5%, 10%, 15%, 20%, 25%, 30%, 40%, 50%, 60%, 70%, 80%, 90%, or more of the total mass, on a dry basis, of the comminuted material. The ratio of oilseeds to wetting agent may be greater than or equal to about 0.1, 0.2, 0.3, 0.4, 0.5, 0.6, 0.7, 0.8, 0.9, 1.0, 1.2, 1.4, 1.6, 1.8, 2.0, 2.2, 2.4, 2.6, 2.8, 3.0, 3.2, 3.4, 3.6, 3.8, 4.0 or greater on a volume basis. In an example, the ratio of oilseeds to wetting agent is 0.6. The oilseed material may additionally be comminuted with a variety of other food product ingredients including, but not limited to, fats and oils, nuts, grains, legumes/pulses, protein isolates/powders, spices, flours, salts, gums, starches, water, coloring agents, flavoring agents, fungus and derivatives thereof, bacteria and derivatives thereof, aquatic plant foods or derivatives thereof, or other plant-based and animal-based (e.g., fish oil, butter, cream, etc.) materials. In an example, the oilseeds are blended with water and a variety of salts, oils, flavoring agents, or any combination thereof. FIG. 6 shows an example of a comminuted oilseed material derived from sunflower seeds that have been boiled.

The dry oilseed-based material may be mixed with one or more wetting agents to form a hydrated oilseed material. The hydrated oilseed material may be a paste, butter-like, cream-like, or slurry material. The wetting agents may include aqueous materials (e.g., water, fruit and/or vegetable juices, broths, brining solutions, etc), oils (e.g., plant, fungus, bacteria, or animal-based oils), or both aqueous materials and oils. The aqueous materials and oils may include, but are not limited, any aqueous or oil material described elsewhere herein. The dry oilseed-based material may be mixed with the wetting agent by stirring, grinding, agitation, pulverizing, blending, or any other comminuting method described herein. Alternatively, or in addition to, the dry oilseed-based material may be the food product. The dry oilseed-based material may be used as an egg substitute for frying, cooking, scrambling, and/or omelet making and/or may be incorporated as an egg-like ingredient during cooking and baking. The dry oilseed-based food product may act as a binding leavening, moistening or hardening agent.

The hydrated oilseed-based material may include insoluble materials. The insoluble materials may or may not be removed from the hydrated oilseed-based materials. Whole oilseed-based materials may comprise insoluble materials (e.g., the hydrated oilseed material has not been treated to remove the insoluble material). Whole oilseed-based materials may or may not be pre-treated to remove off-flavors or outer shells of the oilseeds. Plant-based food products produced using raw oilseed-based materials may have a smooth mouthfeel and be palatable. Insoluble materials (e.g., seed shells, fibers and/or aggregated proteins) may be removed prior to further processing of the food product. Methods for removal of the insoluble materials include, but are not limited to, straining, filtration, centrifugation, gravitational separation, vacuum filtration, or other separation techniques. The hydrated oilseed-based material may have greater than or equal to about 1%, 2%, 3%, 5%, 10%, 15%, 20%, 30%, 40%, 50%, 60%, 70%, 80%, 90%, or more, by weight, of the insoluble components removed. The hydrated oilseed-based material may have between about 10% and 15%, 10% and 20%, 10% and 30%, 10% and 40%, 10% and 50%, 10% and 60%, 10% and 70%, 10% and 80%, or 10% and 90% of the insoluble components removed.

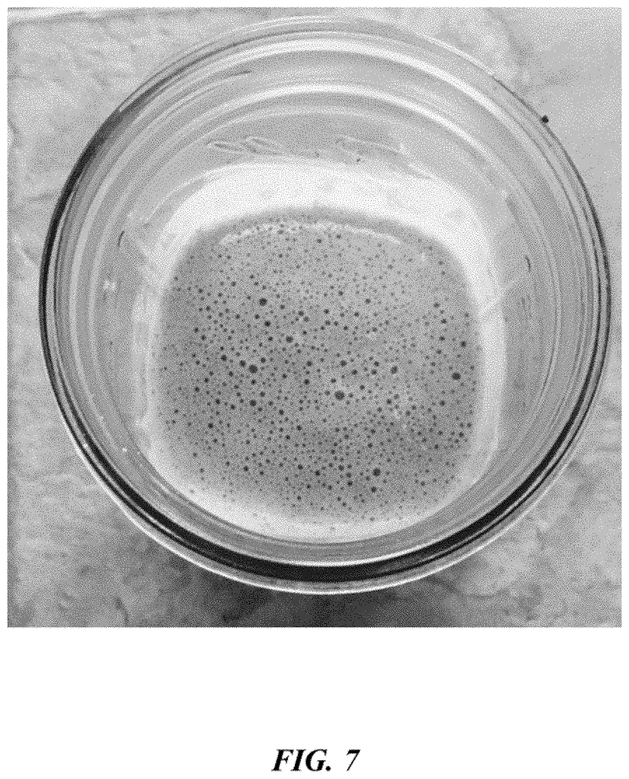

The hydrated oilseed-based material may be the food product. The hydrated oilseed-based food product may be a milk or milk-like product. FIG. 7 shows and example of a plant-based milk product derived from squash seeds. The milk product may or may not comprise insoluble components. The milk product may or may not be pasteurized. The milk product may or may not undergo fermentation with microorganisms to alter the flavor, texture, and/or pigment of the product. The milk or milk product may have one or more added materials including flavoring agents, gelling agents, emulsifying agents, stabilizing agents, protein powders, protein isolates, sweeteners, preservatives, vitamin supplements, mineral supplements, or other nutritional supplements, as described elsewhere herein. The moisture content of the milk or milk product may be altered such that the caloric ratio of the product is between about 10 and 15, 15 and 20, 20 and 40, 20 and 60, 20 and 80, 20 and 100, 20 and 125, 20 and 150, or 20 and 400 calories per eight fluid ounces. Altering the caloric ratio may include diluting, further filtering, concentrating, or adding additional materials to the milk or milk product.

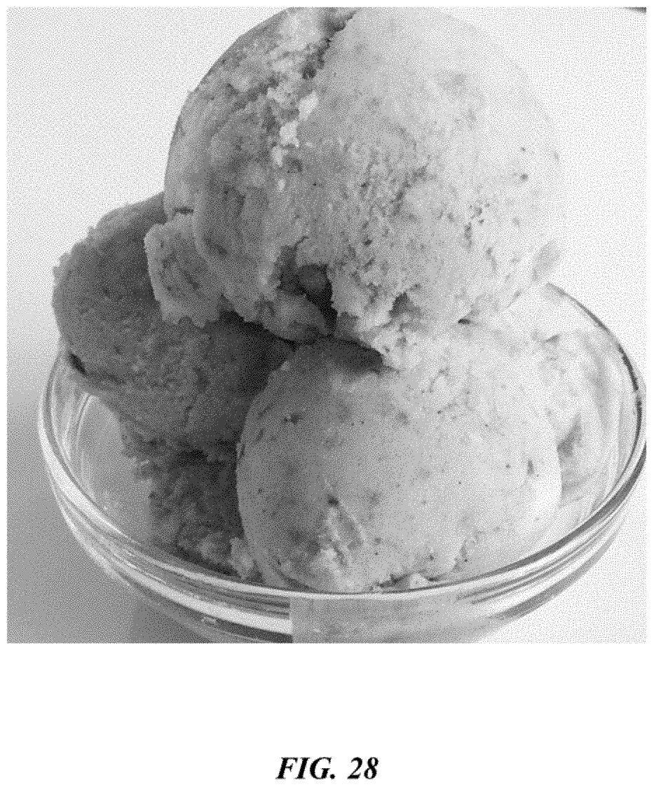

The milk product may be used as the base for making ice cream. FIG. 28 shows an image of a plant-based ice cream replica comprising sunflower seed slurry and fruits. The ice cream may include one or more additional materials such as gums, stabilizing agents, emulsifying agents, gelling agents, thickening agents, sweeteners, flavoring agents, nuts or nut butters, pre-made components (e.g., chocolate, candy, etc.), or any other mixed in ingredients. The one or more additional materials may be added before or after generating the ice cream in an ice cream maker.

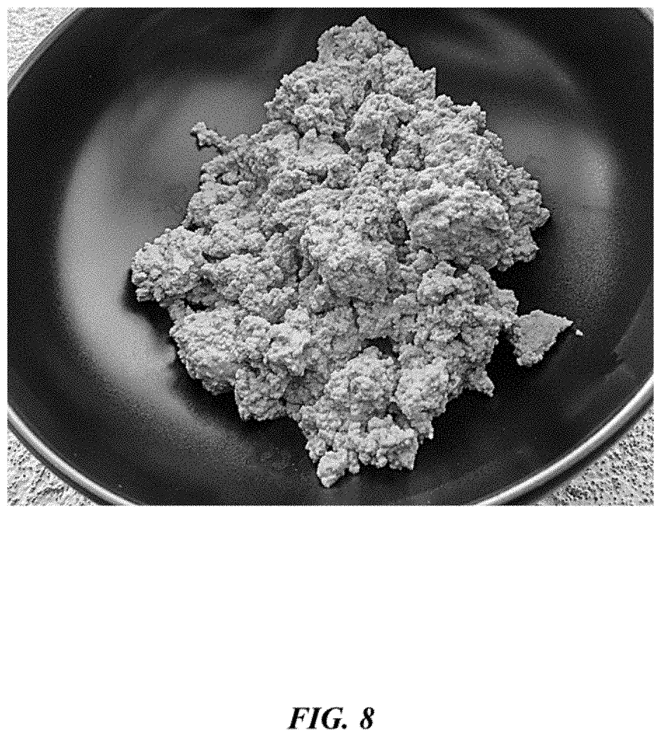

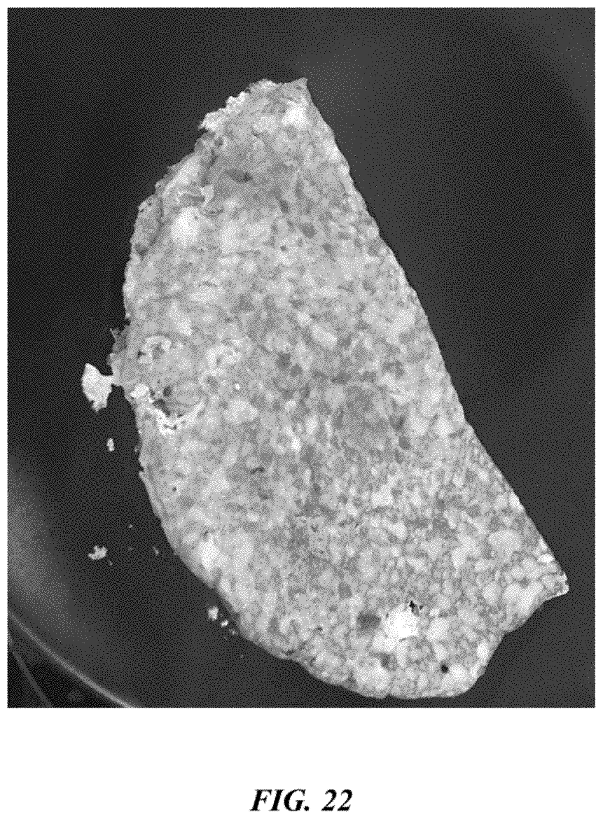

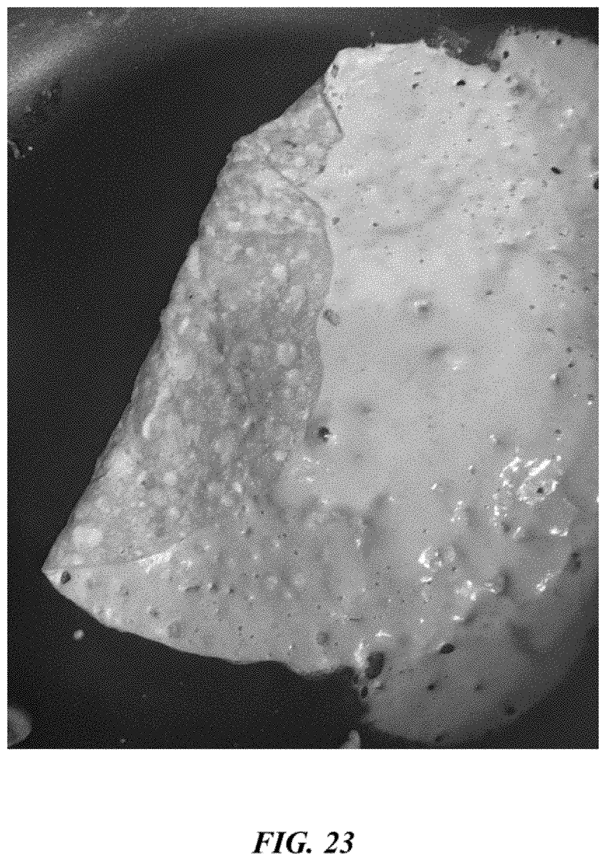

The hydrated oilseed-based food product may be used as an egg substitute and may be incorporated as an egg-like ingredient during cooking and baking. In an example, the egg substitute may be incorporated into sauces (e.g., mayonnaise), custards, and fillings. The hydrated oilseed-based food product may be an egg substitute that is not incorporated into a baking product, but is consumed as egg-like dish (e.g., scrambled eggs, quiche, or omelet). The egg substitute may scramble via protein aggregation upon application of heat (e.g., cooking the material). The proteins in the oilseed-based food product may denature upon application of heat and aggregate to form a scrambled product. The denaturation and aggregation process may occur with or without the aid of a coagulating agent. Coagulating agents used may be any of the coagulating agents described elsewhere herein (e.g., salts, enzymes, acids etc.). In an example, the oilseed-based product comprises squash seed and is an egg substitute. FIG. 8 shows an image of an example of a plant-based scrambled egg product derived from squash seeds and coagulated using heat (e.g., cooking). The hydrated oilseed material may comprise other agents that further improve the gelling capabilities (such as those derived from plants, bacteria, fungus, or animals), rendering it more similar to that of an avian egg. FIG. 22 shows an image of the hydrated material further comprising carrageenan and curdlan that is in process of being cooked into an omelet-like product. FIG. 23 shows an image of the hydrated material further comprising irish sea moss and curdlan that has been cooked into a folded omelet-like product.

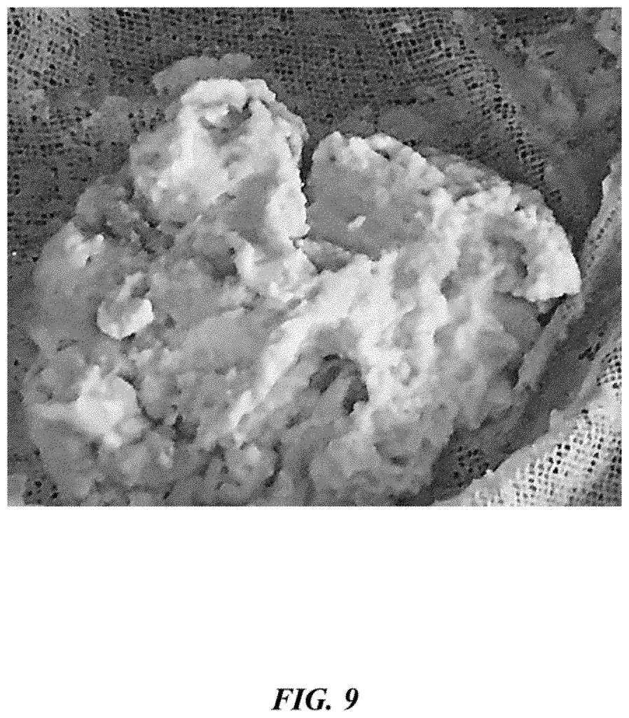

The hydrated oilseed-based material may be fermented to form the food product. FIG. 9 shows an image of an example of a comminuted oilseed material derived from sunflower seed that is coagulated (e.g., fermented) using bacteria without heating. The hydrated oilseed-based material may be first pasteurized, or briefly heated, without inducing coagulation. The hydrated oilseed-based material may or may not be pasteurized prior to or after fermentation. The fermented food product may be a yogurt, kefir, sour cream, cream cheese, buttermilk, labneh, leben, soured milk, lassi, or any other fermented dairy-like product. The fermented food product may include one or more additional materials that may be added to the fermented food product before, during, or after fermentation. The one or more additional materials may be added at one stage of the process (e.g., before or after fermentation) or at multiple stages of the process (e.g., before, during, and after fermentation). The one or more additional material may comprise one or more of flavoring agents, gelling agents, coloring agents, refined sugars, fruit or vegetable juices, syrups, liquid sweeteners, blended or whole fruits or vegetables, fats and oils, protein isolates or protein powders, mineral supplements, coagulating agents, preservatives, or salts. The fermented product may or may not be strained after fermentation to produce a thicker product. For example, greek type yogurts and sour creams may be strained after fermentation. Other product, such as kefir or non-greek type yogurts may not be strained after fermentation.

The hydrated oilseed-based material may further included an added carbon source, such as glucose, sucrose, dextrose, or any other food safe carbon source. The hydrated oilseed-based material may be fermented at a temperature between about 20° C. and 25° C., 20° C. and 30° C., 20° C. and 35° C., 20° C. and 40° C., or 20° C. and 45° C., 25° C. and 30° C., 25° C. and 55° C., 25° C. and 40° C., 25° C. and 55° C., 30° C. and 35° C., 30° C. and 40° C., 40° C. and 45° C., 35° C. and 40° C., 35° C. and 45° C., or 40° C. and 45° C., 45° C. and 50° C., 50° C. and 55° C., 55° C. and 60° C., 60° C. and 65° C., 70° C. and 75° C., 75° C. and 80° C., or 80° C. and 85° C. In an example, the hydrated oilseed-based material is fermented between about 20° C. and 25° C. In another example, the hydrated oilseed-based material is fermented between about 40° C. and 45° C. The hydrated oilseed-based material may be fermented from between about 15 minutes and 5 days hours to alter flavor, smell, texture, and/or pigment. In an example, the hydrated oilseed-based material is fermented for about 3 to 5 days to generate a kefir-like product. In another example, the fermentation time is between about 8 hours and 24 hours to produce a yogurt-like product.

The hydrated oilseed-based material may be fermented using one or more of, but is not limited to, any of the microorganisms described elsewhere herein to form or generate the fermented food product. In an example, the hydrated-oilseed material is fermented using one or more of Bifidobacterium adolescentis, Bifidobacterium animalis, Bifidobacterium bifidum, Bifidobacterium breve, Bifidobacterium infantis, Bifidobacterium lactis, Bifidobacterium longum, Bifidobacterium pseudolongum, Bifidobacterium thermophilum, Candida colliculosa, Carnobactrium maltaromaticum, Enterococcus faecalis, Issatchenkia orientalis, Kazachstania exigua, Kazachstania unispora, Kocuria varians, Lactobacillus acidipiscis, Lactobacillus acidophilus, Lactobacillus brevis, Lactobacillus bulgaricus, Lactobacillus casei, Lactobacillus delbrueckii, Lactobacillus gasseri, Lactobacillus johnsonii, Lactobacillus kefiranofaciens, Lactobacillus kefiri, Lactobacillus nodensis, Lactobacillus parabrevis, Lactobacillus paracasei, Lactobacillus parakefiri, Lactobacillus salivarius, Lactobacillus tucceti, Lactococcus lactis, Leuconostoc pseudomesenteroides, Pichia fermentans, Propionibacterium freudenreichii, Pseudomonas fluorescens, Staphylococcus succinus, Streptococcus thermophilus, Streptococcus gallolyticus, Streptococcus salivarius, Yarrowia lipolytica, and Zygotorulaspora florentina.

The hydrated oilseed-based material may be fermented using microorganisms that are selected to degrade phenolic and other pigmented molecular compounds. Oilseed-based materials may have compounds that render a grey, green, yellow, or brown color that is unpalatable. The color of the fermented food product may be altered using a variety of microorganisms that degrade pigmented molecular compounds. Degradation of phenolic and pigmented molecular compounds may alter the color of the fermented food product from the natural color to a reduced pigment from the original (e.g., from grey to a lighter grey or white or off-white color), with or without increased palatability. A single microorganism may be used or a combination of multiple microorganisms may be used. Microorganisms that may be used to alter the color of the food product include, but are not limited to, Arthrobacter arilaitensis, Arthrobacter bergerei, Arthrobacter globiformis, Arthrobacter nicotianae, Arthrobacter variabilis, Bifidobacterium adolescentis, Bifidobacterium animalis, Bifidobacterium bifidum, Bifidobacterium breve, Bifidobacterium infantis, Bifidobacterium lactis, Bifidobacterium longum, Bifidobacterium pseudolongum, Bifidobacterium thermophilum, Brachybacterium alimentarium, Brachybacterium tyrofermentans, Brevibacterium aurantiacum, Brevibacterium casei, Brevibacterium linens, Candida colliculosa, Candida kefyr, Candida krusei, Candida mycoderma, Candida utilis, Candida vini, Candida zeylanoides, Carnobacterium divergens, Carnobactrium maltaromaticum, Corynebacterium ammoniagenes, Corynebacterium casei, Corynebacterium flavescens, Corynebacterium mooreparkense, Corynebacterium variabile, Cystofilobasidium infirmominiatum, Debaryomyces hansenii, Debaryomyces kloeckeri, Enterococcus faecalis, Fusarium domesticum, Geotrichum candidum, Hafnia alvei, Issatchenkia orientalis, Kazachstania exigua, Kazachstania unispora, Kluyveromyces lactis, Kluyveromyces marxianus, Kocuria rhizophila, Kocuria varians, Lactobacillus acidipiscis, Lactobacillus acidophilus, Lactobacillus brevis, Lactobacillus bulgaricus, Lactobacillus casei, Lactobacillus coryniformis, Lactobacillus curvatus, Lactobacillus delbrueckii, Lactobacilus fermentum, Lactobacillus gasseri, Lactobacillus johnsonii, Lactobacillus kefiranofaciens, Lactobacillus kefiri, Lactobacillus nodensis, Lactobacillus parabrevis, Lactobacillus paracasei, Lactobacillus parakefiri, Lactobacillus paraplantarum, Lactobacillus pentosus, Lactobacillus perolents, Lactobacillus planarum, Lactobacillus rhamnosus, Lactobacillus salivarius, Lactobacillus tucceti, Lactococcus lactis, Lactococcus raffinolactis, Lecanicillium lecanii, Leuconostoc citreum, Leuconostoc pseudomesenteroides, Leuconostoc kimchi, Leuconostoc mesenteroides, Macrococcus caseolyticus, Microbacterium foliorum, Microbacterium gubbeenense, Micrococcus luteus, Mucor racemosus, Penicillium album, Penicillium camemberti, Penicillium caseifulvum, Penicillium chrysogenum, Penicillium commune, Penicillium nalgiovense, Penicillium roqueforti, Pichia fermentans, Propionibacterium acidipropionici, Propionibacterium freudenreichii, Propionibacterium jensenii, Proteus vulgaris, Pseudomonas fluorescens, Psychrobacter celer, Rhodosporidium infirmominiatum, Rhodotorula minuta, Saccharomyces cerevisiae, Staphylococcus carnosus, Staphylococcus equorum, Staphylococcus fieurettii, Staphylococcus saphrophyticus, Staphylococcus sciuri carnaticus, Staphylococcus succinus, Staphylococcus vitulinus, Staphylococcus xylosus, Streptococcus thermophilus, Streptococcus gallolyticus, Streptococcus salivarius, Tetragenococcus delbrueckii, Thrichosporon beigelii, Verticillium lecanii, Yarrowia lipolytica, Zygotorulaspora florentina, or any combination thereof.

The hydrated oilseed-based material may be curdled to create a plant-based (e.g., oilseed-based) curd product. The hydrated oilseed-based material may or may not be pasteurized prior to curdling. Alternatively, or in addition to, the hydrated oilseed-based material may be covered and boiled briefly prior to curdling. The brief boiling may be less than or equal to 60 minutes, 40 minutes, 30 minutes, 10 minutes, 5 minutes, 4 minutes, 3 minutes, 2 minutes, 1.5 minutes, 1 minute, 45 seconds, 30 seconds, 15 second, 10 seconds, 5 seconds, or less. The time period described herein are for small scale production and may vary during larger scale production. One or more additional materials may be added to the hydrated oilseed-based material prior to, during, or after curdling. Additional materials may include nuts, soybeans, nuts, legumes, grains, flours, fats and oils, protein isolates, protein powders, spices, salts, gums, starches, amino acid isolates, flavoring, plant matter, microbial matter (e.g., fungal, bacterial, or algal), complex fungal matter (e.g., multicellular fungus), animal matter, or any other additional materials described herein.

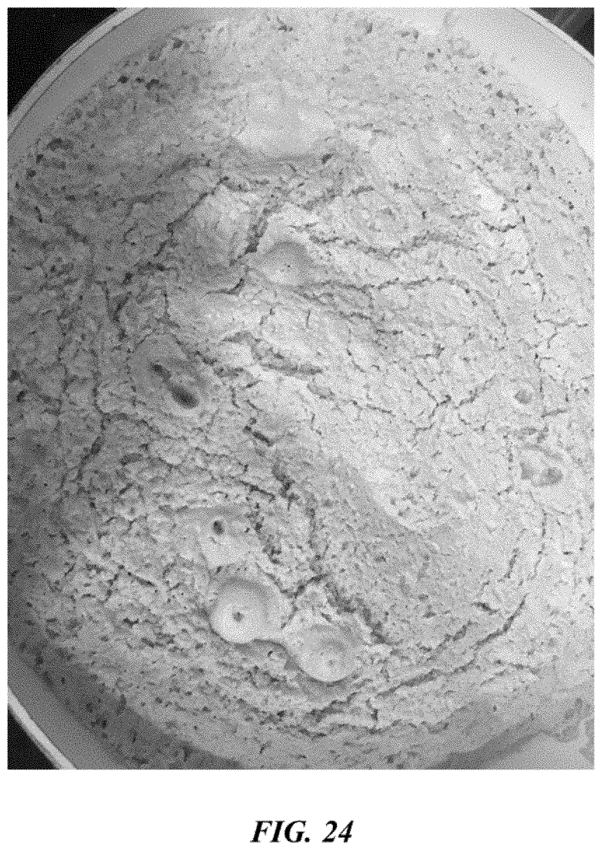

The hydrated oilseed-based material may be curdled using heat-based curdling, coagulant-induced curling, enzyme-induced coagulation, microbial-induced coagulation, or any combination thereof. Heat-based curdling may cause thermal aggregation of the proteins within the hydrated oilseed-based material, which may form curds. FIG. 24 shows an image of a sunflower seed slurry, without any filtration and formed into curds using steam treatment to induce thermal aggregation. Heat-based curdling may include heating the hydrated oilseed-based material at a temperature of greater than or equal to about 80° C., 82° C., 84° C., 86° C., 88° C., 90° C., 92° C., 94° C., 96° C., 98° C., 100° C., or higher. The hydrated oilseed-based material may be heated to a temperature between about 80° C. and 82° C., 80° C. and 84° C., 80° C. and 86° C., 80° C. and 88° C., 80° C. and 90° C., 80° C. and 92° C., 80° C. and 94° C., 80° C. and 96° C., 80° C. and 98° C., or 80° C. and 100° C. The hydrated oilseed-based material may be heated for greater than or equal to about 1 minute, 2 minutes, 3 minutes, 4 minutes, 6 minutes, 8 minutes, 10 minutes, 12 minutes, 15 minutes, 20 minutes, 25 minutes, 30 minutes, 40 minutes, or more. The hydrated oilseed-based material may be heated from between 1 minute and 2 minutes, 1 minute and 3 minutes, 1 minute and 4 minutes, 1 minute and 6 minutes, 1 minute and 8 minutes, 1 minute and 10 minutes, 1 minute and 12 minutes, 1 minute and 15 minutes, 1 minute and 20 minutes, 1 minute and 25 minutes, 1 minute and 30 minutes, or 1 minute and 40 minutes. In an example, the hydrated oilseed-based material is heated for about 12 to 25 minutes. In another example, the hydrated oilseed-based material is heated for about 4 to 10 minutes. In another example, hydrated oilseed-based material is heated for about 10 to 20 minutes. The hydrated oilseed-based material may or may not be stirred constantly during heating. The hydrated oilseed-based material may be removed from heat and cooled. The curds may form during heating or during cooling. The curdling product may be incubated (e.g., in an ambient, reduced, or elevated temperature environment) to cool, warm, and/or curdle for greater than or equal to about 10 minutes, 15 minutes, 20 minutes, 25 minutes, 30 minutes, 40 minutes, 50 minutes, 60 minutes, 80 minutes, 100 minutes, or more. In an example, the curdling product is incubated to cool and/or curdle for between 5 and 60 minutes, depending on batch size.

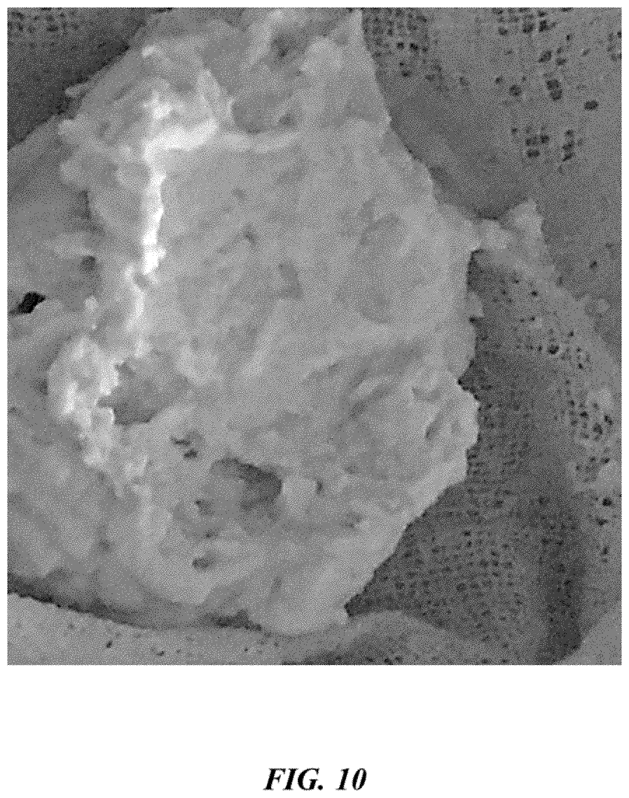

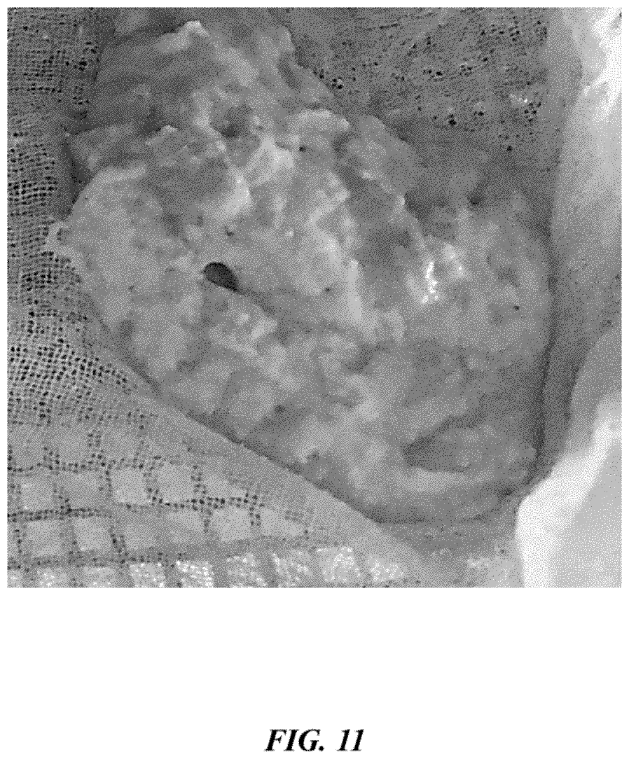

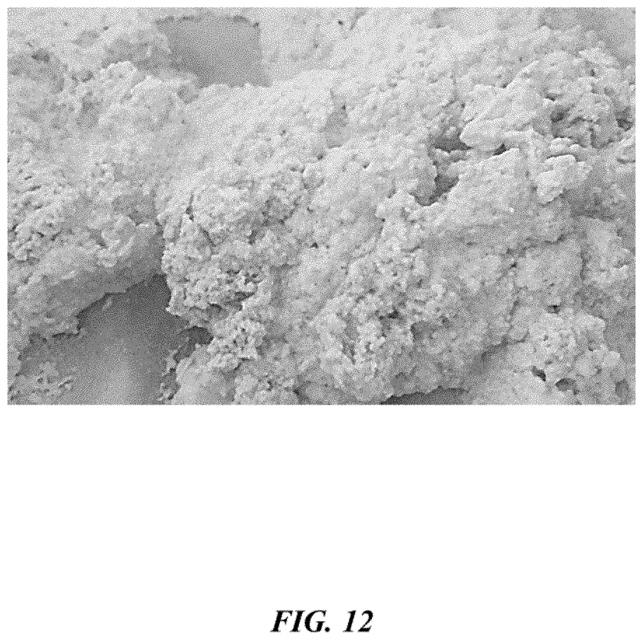

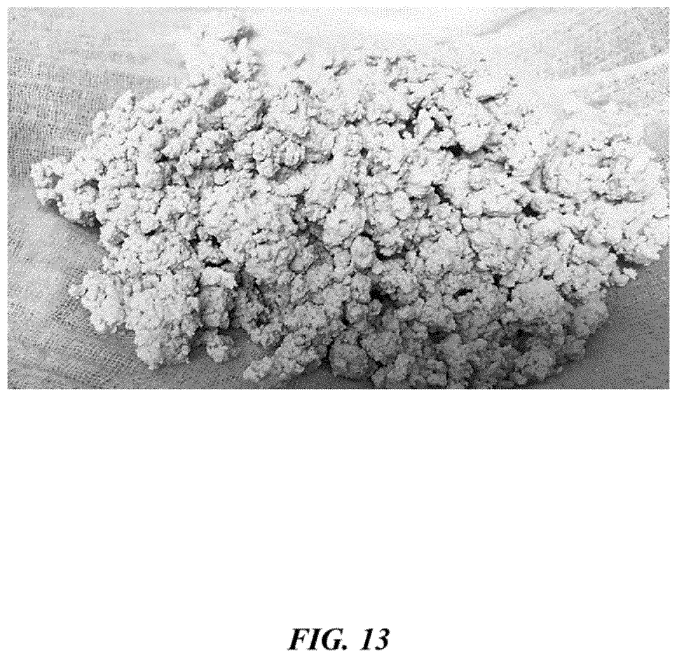

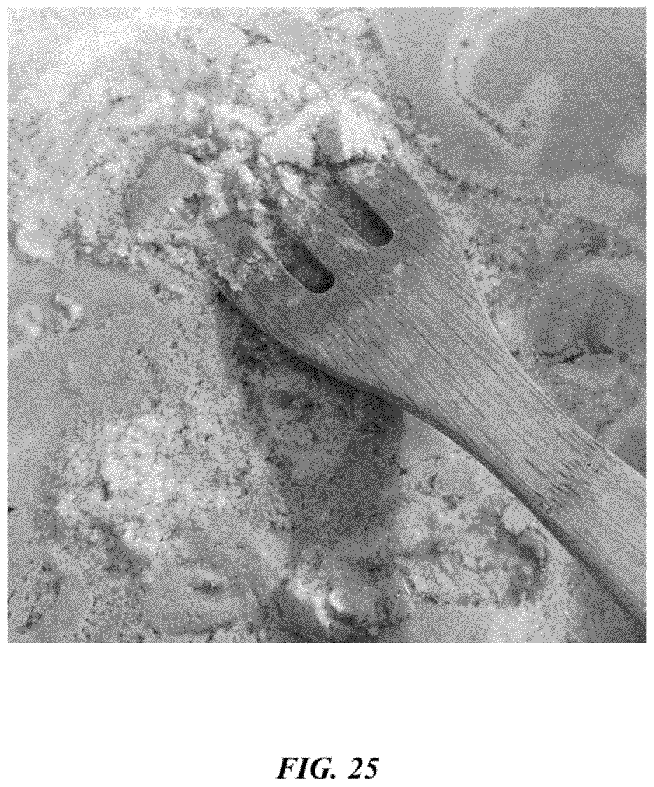

Alternatively, or in addition to, the hydrated oilseed-based material may be curdled using a coagulating agent. Coagulating agents may one or more of an acid (e.g., citrus juice, vinegar, citric acid, tartaric acid, etc.), coagulating salt (e.g., calcium sulfate, magnesium chloride, calcium chloride, sodium chloride, potassium chloride, glucono delta-lactone, rock salt), enzymes, or microorganisms (e.g., bacteria or fungi). FIG. 10 shows an image of an example of a comminuted oilseed material derived from sunflower seeds that is coagulated using acid without a heating step. Coagulating enzymes may include crosslinking enzymes or proteases, such as papain or thermolysin derived from Bacillus subtilis, Aspergillus oryzae, Bacillus thermoproteolyticus, Bacillus polymyxa, Endothia parasitica, Mucor miehei, Bromelain, Endothia parasitica, Mucor miehei, Saccharomyces bayous (SCY003), or any other food safe microorganisms from the same Kingdom. FIG. 11 shows an image of an example of a comminuted oilseed material derived from sunflower seeds that is coagulated using an enzyme without a heating step. Coagulating enzymes may or may not include enzymes that crosslink the protein aggregates. Microorganisms used for coagulating agents may be any microorganisms described elsewhere herein. Prior to the addition of coagulating agents, the hydrated oilseed-based material may or may not be pasteurized. The coagulating agents may be added during any stage of the process including, but not limited to, during comminution, during hydration, during fermentation, or prior to or after inducing curdling. Coagulating agents may comprise greater than or equal to about 0.0001%, 0.001%, 0.01%, 0.1%, 0.5%, 1%, 1.5%, 2%, 3%, 4%, 5%, 6%, 7%, 8%, 9%, or more of the food product by dry weight. Coagulating agents may be added to the composition between 0.0001% and 9% by dry weight. In an example, thermal coagulation and salt based coagulation are performed simultaneously. FIG. 12 shows an image of an example of a comminuted oilseed material derived from sunflower seeds that is coagulated using heat and a sodium chloride coagulating agent. Another example of salt based coagulation is shown in FIG. 13, which shows an image of example plant-based curds derived from squash seeds that are coagulated using sodium chloride and calcium sulfate coagulating agents. FIG. 25 shows an image of sunflower seed curds that have been comminuted, partially filtered, and coagulated using heat and acid. In another example, enzyme coagulating agents are used and the hydrated oilseed-based material is incubated for between 10 to 30 minutes to curdle the material.

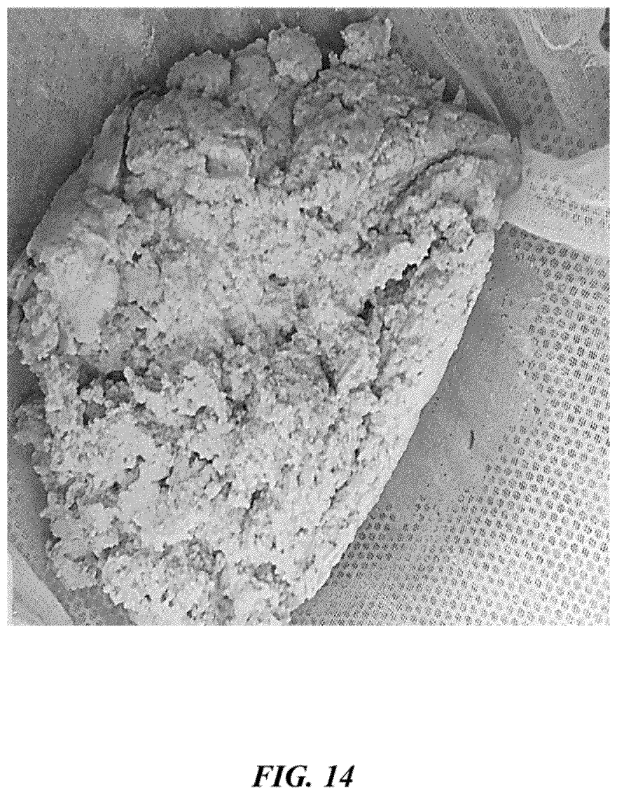

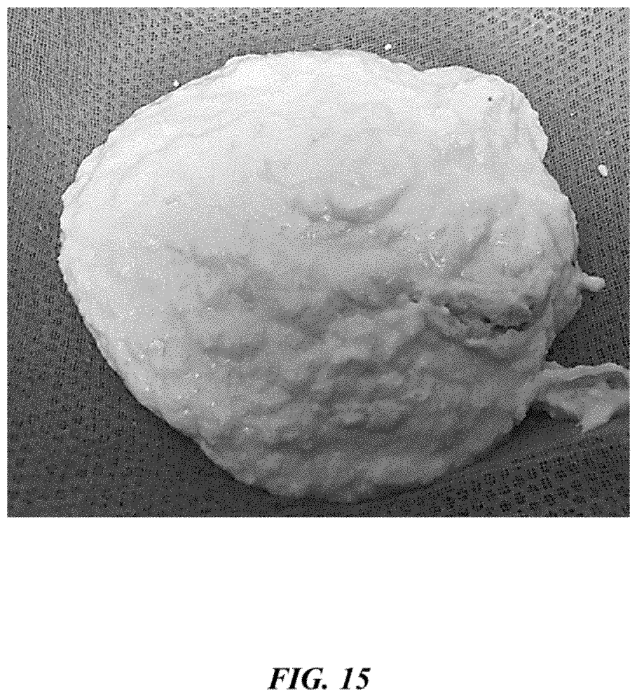

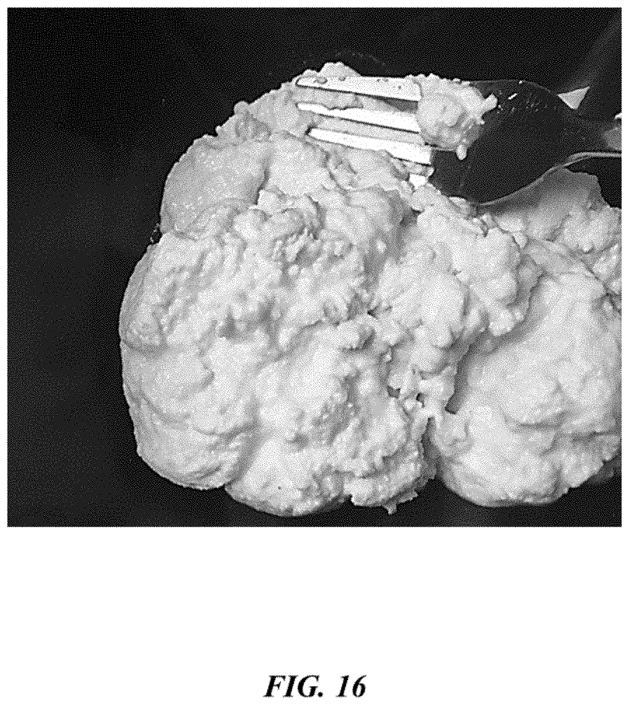

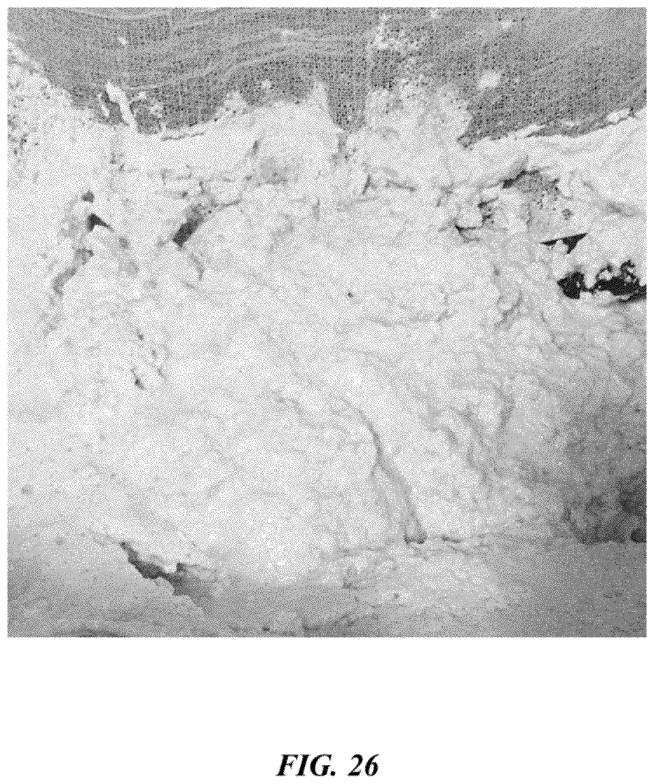

The plant-based curd may be the produced food product. Alternatively, or in addition to, the plant-based curd may be further processed to generate a secondary product. The secondary product may include a tofu-like product or a cheese-like product. Prior to forming the secondary product, the curd may be strained to separate the curd from the whey. FIG. 14 shows an image of an example of a comminuted oilseed material derived from sunflower seeds that is coagulated using heat and a sodium chloride coagulating agent followed by draining the curds from the whey. FIG. 15 shows an image of another example of a comminuted oilseed material derived from peanuts that is coagulated using heat and a sodium chloride and calcium sulfate coagulating agents followed by draining the curds from the whey. FIG. 16 shows an image of another example of a comminuted oilseed material derived from peanuts that is coagulated using heat and a sodium chloride and calcium chloride coagulating agents followed by draining the curds from the whey. FIG. 26 shows and image of sunflower and squash seed curds that have been comminuted into an aqueous mixture, partially filtered, coagulated using heat, salts, and acids, and drained of whey to form a curd. One or more additional materials may be added to the separated curd. Additional material may include of nuts, soybeans, nuts, legumes, grains, flours, fats and oils, protein isolates, protein powders, spices, salts, gums, starches, amino acid isolates, flavoring, plant matter, microbial matter (e.g., fungal, bacterial, or algal), complex fungal matter (e.g., multicellular fungus), animal matter, or any other materials described herein. Any off-flavors of the curds may be removed by carbon exposure, steam treatment, or chemical processing.

The curd, separated or non-separated, may be combined with one or more of hydrocolloid, gelling agent, coagulating agent, fat, protein, starch, and/or flavoring agent. In an example, the separated curd is mixed with a starch and a protein. The starch may be a plant-based starch and may mimic the behavior of casein to add stretchability to the food product. In an example, the food product is a cheese replica and the start permits the cheese to be thermoreversible (e.g., to melt). Alternatively, or in addition to, the curd may be mixed with one or more proteins. The proteins may be protein isolates, protein concentrates, or crude proteins. The proteins may be derived from synthetically grown muscle tissue, plant sources, or fungal sources. The protein may be combined with a fat or oil to form an emulsified protein. The emulsified protein may be added to and mixed with the curd.

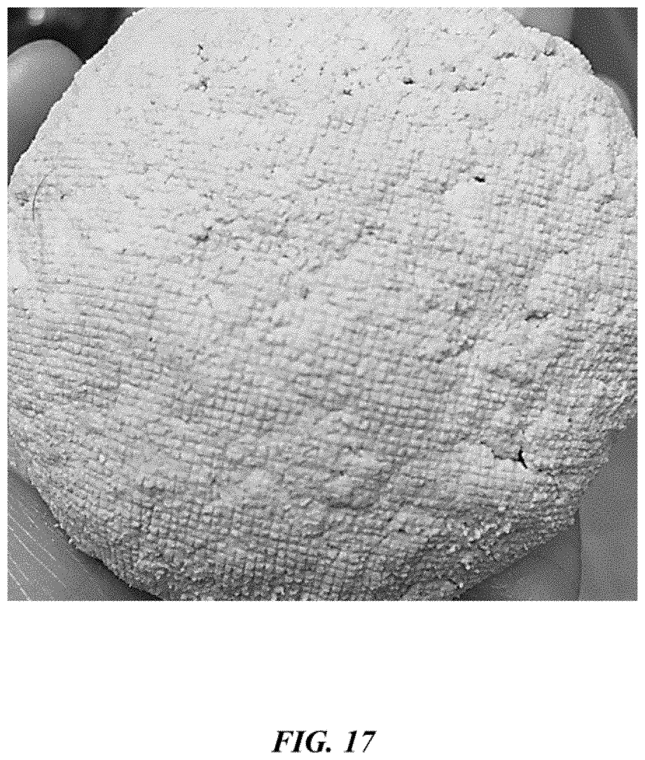

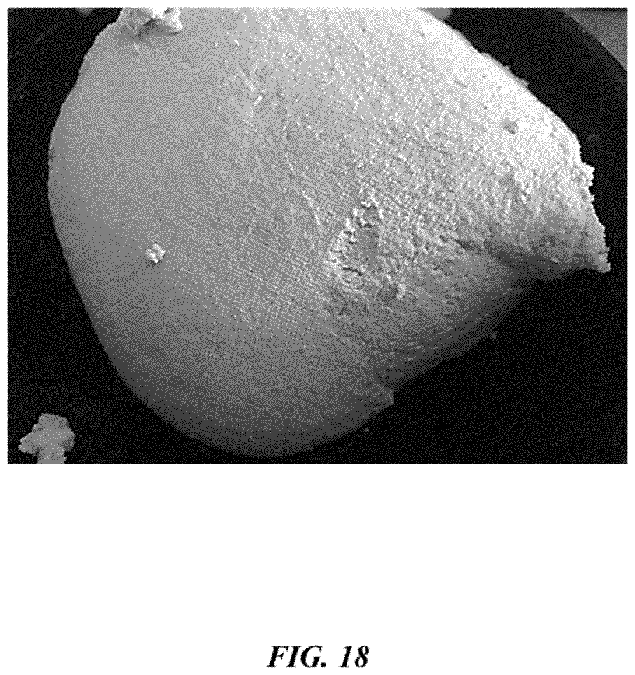

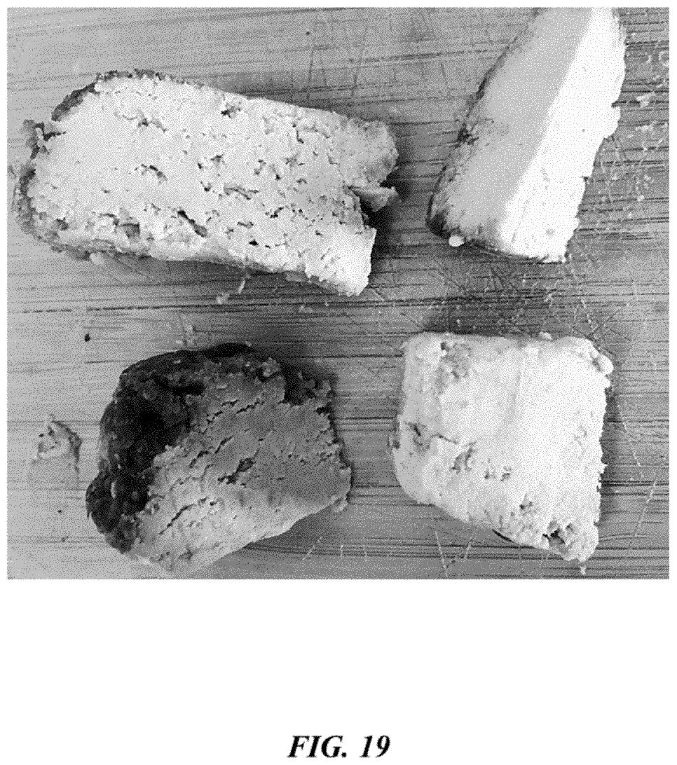

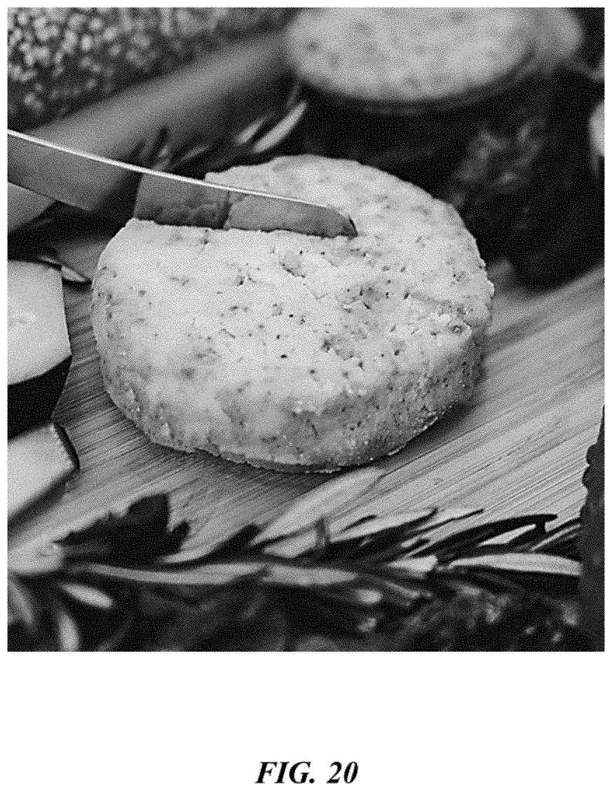

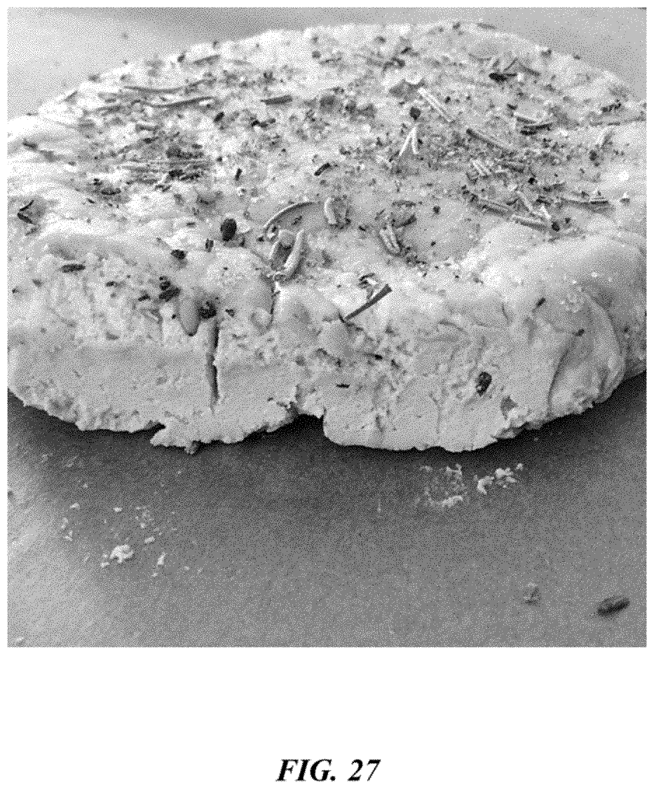

The separated curd may be further processed by emulsifying, gelling, fermenting aging, drying, or any combination thereof in any order. In an example, the curd is pressed to form a tofu-like product. FIG. 17 shows an image of an example of a squash seed tofu-like product that is coagulated using sodium chloride and calcium sulfate coagulating agents followed by draining the curds from the whey and pressing. FIG. 18 shows an image of an example of a comminuted oilseed material derived from sunflower seeds that is coagulated using heat and a sodium chloride coagulating agent followed by draining the curds from the whey, flavoring agents, and fermenting with bacteria to form a ricotta cheese product. FIG. 19 shows another example of a plant-based cheese product derived from squash seeds. In another example, the curd is pressed and fermented to form a cheese-like product. Alternatively, or in addition to, a cheese-like product may be formed by fermentation without pressing. The curd product may be mixed with additional materials, including microorganisms (e.g., fungi or bacteria) and/or flavoring agents. The curd may be pressed or may not be pressed prior to fermenting with the fungi or bacteria. The fungi or bacteria may facilitate a color change in the product to generate a cheese that is white or off-white. The cheese may be optionally dehydrated to increase the rate of fermentation and to form a firm cheese. The cheese may be aged in a cold dry place before, during, or after fermentation, depending upon the type of cheese to be produced. An example aged cheese is shown in FIG. 20, which is an image of an example of a comminuted oilseed material derived from peanuts that is coagulated using magnesium chloride and calcium sulfate coagulating agents followed by draining the curds from the whey and aging with a bacteria and flavorings. FIG. 27 shows an image of a plant-based cheese replica comprising sunflower and squash seed material formed by comminution, partial filtration, and head induce coagulation using salts.

### Computer Control Systems

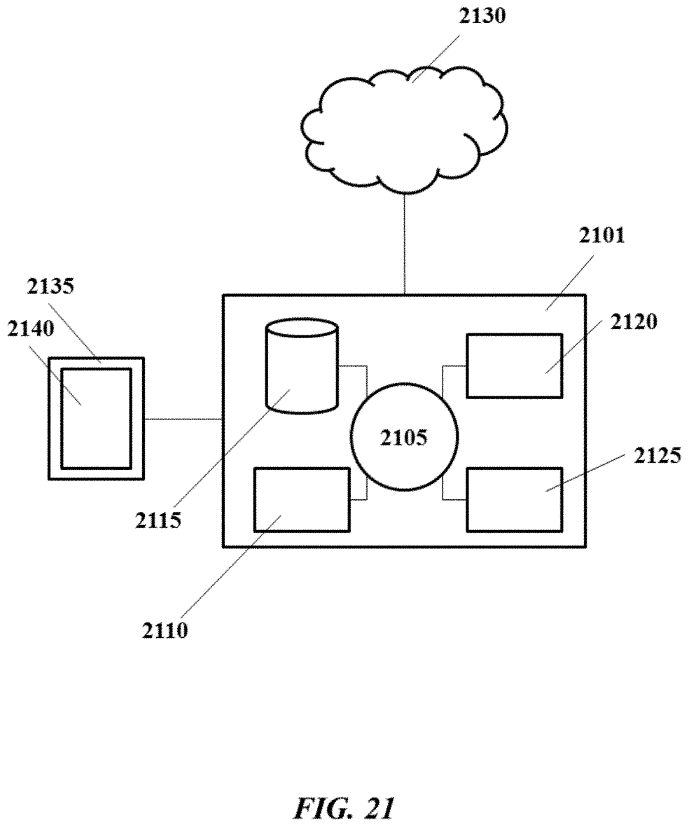

The present disclosure provides computer control systems that are programmed to implement methods of the disclosure. FIG. 21 shows a computer system 2101 that is programmed or otherwise configured to control, direct, or implement the methods described herein. The computer system 2101 can regulate various aspects of oilseed processing and fermentation of the present disclosure, such as, for example, monitoring and controlling oilseed comminution, hydration, curdling, and fermentation. The computer system 2101 can be an electronic device of a user or a computer system that is remotely located with respect to the electronic device. The electronic device can be a mobile electronic device that is wirelessly connected to the computer system.

The computer system 2101 includes a central processing unit (CPU, also “processor” and “computer processor” herein) 2105, which can be a single core or multi core processor, or a plurality of processors for parallel processing. The computer system 2101 also includes memory or memory location 2110 (e.g., random-access memory, read-only memory, flash memory), electronic storage unit 2115 (e.g., hard disk), communication interface 2120 (e.g., network adapter) for communicating with one or more other systems, and peripheral devices 2125, such as cache, other memory, data storage and/or electronic display adapters. The memory 2110, storage unit 2115, interface 2120 and peripheral devices 2125 are in communication with the CPU 2105 through a communication bus (solid lines), such as a motherboard. The storage unit 2115 can be a data storage unit (or data repository) for storing data. The computer system 2101 can be operatively coupled to a computer network (“network”) 2130 with the aid of the communication interface 2120. The network 2130 can be the Internet, an interne and/or extranet, or an intranet and/or extranet that is in communication with the Internet. The network 2130 in some cases is a telecommunication and/or data network. The network 2130 can include one or more computer servers, which can enable distributed computing, such as cloud computing. The network 2130, in some cases with the aid of the computer system 2101, can implement a peer-to-peer network, which may enable devices coupled to the computer system 2101 to behave as a client or a server.

The CPU 2105 can execute a sequence of machine-readable instructions, which can be embodied in a program or software. The instructions may be stored in a memory location, such as the memory 2110. The instructions can be directed to the CPU 2105, which can subsequently program or otherwise configure the CPU 2105 to implement methods of the present disclosure. Examples of operations performed by the CPU 2105 can include fetch, decode, execute, and writeback.

The CPU 2105 can be part of a circuit, such as an integrated circuit. One or more other components of the system 2101 can be included in the circuit. In some cases, the circuit is an application specific integrated circuit (ASIC).

The storage unit 2115 can store files, such as drivers, libraries and saved programs. The storage unit 2115 can store user data, e.g., user preferences and user programs. The computer system 2101 in some cases can include one or more additional data storage units that are external to the computer system 2101, such as located on a remote server that is in communication with the computer system 2101 through an intranet or the Internet.

The computer system 2101 can communicate with one or more remote computer systems through the network 2130. For instance, the computer system 2101 can communicate with a remote computer system of a user (e.g., system operator or food technician). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 2101 via the network 2130.

Methods as described herein can be implemented by way of machine (e.g., computer processor) executable code stored on an electronic storage location of the computer system 2101, such as, for example, on the memory 2110 or electronic storage unit 2115. The machine executable or machine readable code can be provided in the form of software. During use, the code can be executed by the processor 2105. In some cases, the code can be retrieved from the storage unit 2115 and stored on the memory 2110 for ready access by the processor 2105. In some situations, the electronic storage unit 2115 can be precluded, and machine-executable instructions are stored on memory 2110.

The code can be pre-compiled and configured for use with a machine having a processer adapted to execute the code, or can be compiled during runtime. The code can be supplied in a programming language that can be selected to enable the code to execute in a pre-compiled or as-compiled fashion.

Aspects of the systems and methods provided herein, such as the computer system 2101, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 2101 can include or be in communication with an electronic display 2135 that comprises a user interface (UI) 2140 for providing, for example, information relating to the current operation, operation history, and operation set points for the oilseed comminution, curdling, and/or fermentation processes. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 2105. The algorithm can, for example, alter operating conditions of the comminution, curdling, and/or fermentations processes in response to system inputs. Inputs may include, but are not limited to, temperature, pH, and time.

### EXAMPLES

### Cheese 1

Three cups of sunflower and/or safflower seed are soaked and heat rinsed. The seeds are comminuted with 1 teaspoon sea salt, 2 tablespoons oil, and about 5 cups of water by blending. The blended material is covered and boiled for 10 to 20 minutes. The boiling mixture is gently stirred once every minute or two during the boiling process. After boiling, the mixture is removed from the heat, strained, and cooled. The cooled mixture is mixed with 2.85 teaspoons calcium carbonate, 1.5 teaspoons sea salt, 0.125 teaspoons sugars, microbes, and flavoring agents (e.g., garlic, onion, sumac, cinnamon, etc.). The material is dehydrated or incubated for 1 to 36 hours to accelerate fermentation. Additional bacteria, fungi, herbs, and spices are added. The fermented material is refrigerated for use as a cheese or may be cold aged in a dry, cool place to form an aged cheese.

### Cheese 2

Three cups of sunflower and/or safflower seed are soaked and heat rinsed. The seeds are comminuted with 1 teaspoon sea salt and about 5 cups of water by blending. The blended material is treated to remove some of the insoluble material (e.g., 10% to 90%) by straining. The strained material is covered and boiled for 4 to 10 minutes without stirring. After boiling, the mixture is removed from the heat, strained, and cooled. The cooled mixture is mixed with 1.5 teaspoons calcium carbonate, 0.75 teaspoons sea salt, 0.06 teaspoons sugars, microbes, and flavoring agents (e.g., garlic, onion, sumac, cinnamon, etc.). The material is dehydrated or incubated for 1 to 36 hours to accelerate fermentation. Additional microorganisms herbs, and spices are added. The fermented material is refrigerated for use as a cheese or may be cold aged in a dry, cool place to form an aged cheese.

### Cheese 3

Three cups of peanut and/or sesame seed are soaked and heat rinsed. The seeds are comminuted with 1 teaspoon sea salt and about 5 cups of water by blending. The blended material is treated to remove some of the insoluble material (e.g., 10% to 90%) by straining. The strained material is covered and boiled briefly such that no curds form. After boiling, 0.5 teaspoons of calcium sulfate and 0.5 teaspoons of magnesium chloride are stirred into the blended material. The material is incubated for between 5 and 60 minutes to form curds. The curds mixture is combined with 1.5 teaspoons sea salt, 0.0625 teaspoons sugars, microorganisms, and flavoring agents (e.g., garlic, onion, sumac, cinnamon, synthetically or naturally derived flavor compounds, etc.). The material is dehydrated or incubated for 1 to 46 hours to accelerate fermentation. Additional bacteria, fungi, herbs, and spices are added. The fermented material is refrigerated for use as a cheese or may be cold aged in a dry, cool place to form an aged cheese.

### Cheese 4

Three cups of sunflower and/or safflower seed are soaked and heat rinsed. The seeds are comminuted with 1 teaspoon sea salt and about 5 cups of water by blending. The blended material is treated to remove some of the insoluble material (e.g., 10% to 90%) by straining. The strained material is covered and boiled for 4 to 10 minutes with constant stirring. After boiling, the strained material is mixed with 0.75 teaspoon salt, 0.06 teaspoons sugar, microorganisms, and flavoring agents. The material is dehydrated for 1 to 36 hours to accelerate fermentation. Additional bacteria, fungi, herbs, and spices are added. The fermented material is refrigerated for use as a cheese or may be cold aged in a dry, cool place to form an aged cheese. A portion of the fermented and/or aged curd are emulsified with such that 1 cup of curd is mixed with 0.3 cups oil, 2 tablespoons tapioca starch, and 1 tablespoon carrageenan or agar-agar. The product may be heated to activate the agar-agar and tapioca. The mixture is heated, cooled, and additional flavoring agents (e.g., jalapenos and garlic) are added. The cooled mixture is refrigerated to solidify and microorganisms are added and the product is aged further.

### Cheese 5

Three cups of sunflower and/or safflower seed are soaked and heat rinsed. The seeds are comminuted with 1 teaspoon sea salt and about 5 cups of water by blending. The blended material is treated to remove some of the insoluble material (e.g., 10% to 90%) by straining. The strained material is covered and boiled briefly such that no curds form. After boiling, the mixture is cooled to below 48° C. and microbes are added. The product is incubated with the microbes for 30 minutes to 15 hours until some cords have formed. The curds mixture may be combined with 1.5 teaspoons calcium carbonate, 0.75 teaspoons sea salt, microorganisms, and optionally flavoring agents. The material is dehydrated for 14 to 46 hours to accelerate fermentation. Additional bacteria, fungi, herbs, and spices are added to form products such as brie or blue cheese analogues. The fermented material is refrigerated for use as a cheese or may be cold aged in a dry, cool place to form an aged cheese.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

1. A composition comprising a plant-based fermentation product comprising (i) at least about 5% whole oilseed material by dry weight, (ii) greater than 5% protein by caloric value, and (iii) one or more microorganisms selected from the group consisting of Bifidobacterium adolescentis, Bifidobacterium animalis, Bifidobacterium bifidum, Bifidobacterium breve, Bifidobacterium infantis, Bifidobacterium lactis, Bifidobacterium longum, Bifidobacterium pseudolongum, Bifidobacterium thermophilum, Candida colliculosa, Carnobactrium maltaromaticum, Enterococcus faecalis, Issatchenkia orientalis, Kazachstania exigua, Kazachstania unispora, Kocuria varians, Lactobacillus acidipiscis, Lactobacillus acidophilus, Lactobacillus brevis, Lactobacillus bulgaricus, Lactobacillus casei, Lactobacillus delbrueckii, Lactobacillus gasseri, Lactobacillus johnsonii, Lactobacillus kefiranofaciens, Lactobacillus kefiri, Lactobacillus nodensis, Lactobacillus parabrevis, Lactobacillus paracasei, Lactobacillus parakefiri, Lactobacillus salivarius, Lactobacillus tucceti, Lactococcus lactis, Leuconostoc pseudomesenteroides, Pichia fermentans, Propionibacterium freudenreichii, Pseudomonas fluorescens, Staphylococcus succinus, Streptococcus thermophilus, Streptococcus gallolyticus, Streptococcus salivarius, Yarrowia lipolytica, and Zygotorulaspora florentina.

2. The composition of claim 1, wherein said composition comprises at least about 10% whole oilseed material by dry weight.

3. The composition of claim 1, wherein said at least about 5% whole oilseed material by dry weight is selected from the group consisting of squash seeds, sunflower seeds, safflower seeds, peanuts, soybeans, cotton seeds, rape seeds, sesame seeds, hemp seeds, flax seeds, chia seeds, mustard seeds, vegetable seeds, and poppy seeds.

4. The composition of claim 3, wherein said at least about 5% whole oilseed material by dry weight comprises sunflower seeds.

5. The composition of claim 1, further comprising one or more materials selected from the group consisting of nuts, soybeans, nuts, legumes, grains, flours, fats and oils, protein isolates, protein powders, spices, salts, gums, starches, amino acid isolates, flavoring agents, plant matter, additional microbial matter or derivatives thereof, and animal matter.

6. The composition of claim 1, further comprising one or more added oils.

7. The composition of claim 6, wherein less than or equal to about 20% by weight of said composition comprises said one or more added oils.

8. The composition of claim 1, further comprising probiotic cultures.

9. A composition comprising a plant-based fermentation product comprising at least about 5% oilseed material by dry weight, wherein said composition (i) comprises one or more microorganisms capable of degrading pigmented molecular compounds, and (ii) is of a white or off-white color.

10. The composition of claim 9, wherein said one or microorganisms are capable of degrading phenolic compounds.

11. The composition of claim 9, wherein said composition comprises at least about 10% oilseed material by dry weight.

12. The composition of claim 11, wherein said composition comprises at least about 20% oilseed material by dry weight.

13. The composition of claim 9, wherein said oilseed material is selected from the group consisting of squash seeds, sunflower seeds, safflower seeds, peanuts, soybeans, cotton seeds, rape seeds, sesame seeds, hemp seeds, flax seeds, chia seeds, mustard seeds, vegetable seeds, poppy seeds, or other oily seeds.

14. The composition of claim 13, wherein said at least about 5% oilseed material by dry weight comprises sunflower seeds.

15. The composition of claim 9, further comprising one or more materials selected from the group consisting of nuts, legumes, grains, flours, fats and oils, protein isolates, protein powders, spices, salts, gums, starches, amino acid isolates, flavoring agents, preservatives, nutritional supplements, plant matter, additional microbial matter or derivatives thereof, and animal matter.

16. The composition of claim 9, further comprising a coagulating agent.

17. The composition of claim 9, further comprising a moisture content between about 50% and 60% by weight.

18. The composition of claim 9, further comprising one or more added oils.

19. The composition of claim 18, wherein less than or equal to about 20% by weight of said composition comprises said one or more added oils.

20. The composition of claim 9, further comprising probiotic cultures.
